(19) United States
(12) Patent Application Publication
(10) Pub. No.: US 2026/0087759 A1
(43) Pub. Date: Mar. 26, 2026

(54) SURFACE-BASED INTERACTIONS AND OPERATIONS WITHIN MULTI-USER COMMUNICATION SESSIONS

(71) Applicant: Apple Inc., Cupertino, CA (US)

(72) Inventors: Connor A. SMITH, San Jose, CA (US); Anish KANNAN, Sunnyvale, CA (US); Kevin LEE, San Jose, CA (US); Alexander Burling RODRIGUEZ, Mountain View, CA (US)

(21) Appl. No.: 19/299,087

(22) Filed: Aug. 13, 2025

Related U.S. Application Data
(60) Provisional application No. 63/698,847, filed on Sep. 25, 2024.
(60) Provisional application No. 63/817,642, filed on Jun. 4, 2025.

(51) Int. Cl. G06T 19/20; G06T 15/10

(52) U.S. Cl. CPC G06T 19/20; G06T 15/10; G06T 2219/2004

(57) ABSTRACT

Some examples of the disclosure are directed to systems and methods for displaying virtual content relative to a surface of a three-dimensional environment within a multi-user communication session. Some examples of the disclosure are directed to systems and methods for moving virtual content vertically in a three-dimensional environment relative to a surface of the three-dimensional environment within a multi-user communication session.

### CROSS REFERENCE TO RELATED APPLICATIONS

This application claims the benefit of U.S. Provisional Application No. 63/698,847, filed Sep. 25, 2024, and U.S. Provisional Application No. 63/817,642, filed Jun. 4, 2025, the contents of which are herein incorporated by reference in their entireties for all purposes.

### FIELD OF THE DISCLOSURE

This relates generally to systems and methods of establishing spatial truth (e.g., based on synchronized reference points) and facilitating vertical movement of virtual content based on surfaces (e.g., physical surfaces) included in a three-dimensional environment in multi-user communications.

### BACKGROUND OF THE DISCLOSURE

Some computer graphical environments provide two-dimensional and/or three-dimensional environments where at least some objects displayed for a user's viewing are virtual and generated by a computer. In some examples, the three-dimensional environments are presented by multiple devices communicating in a multi-user communication session. In some examples, an avatar (e.g., a representation) of each non-collocated user participating in the multi-user communication session (e.g., via the computing devices) is displayed in the three-dimensional environment of the multi-user communication session. In some examples, content can be shared in the three-dimensional environment for viewing and interaction by multiple users participating in the multi-user communication session.

### SUMMARY OF THE DISCLOSURE

Some examples of the disclosure are directed to systems and methods for displaying virtual content relative to a surface of a three-dimensional environment within a multi-user communication session. In some examples, a method is performed at a first electronic device in communication with one or more displays and one or more input devices. In some examples, while in a communication session with a second electronic device and while displaying, via the one or more displays, a visual representation of a user of the second electronic device in a three-dimensional environment, wherein the visual representation is displayed at a first height relative to a first surface in the three-dimensional environment from a viewpoint of the first electronic device, the first electronic device receives a first indication of a request to share content of a first type in the communication session. In some examples, in response to receiving the first indication, the first electronic device displays, via the one or more displays, a first object corresponding to the content of the first type in the three-dimensional environment. In some examples, while displaying the first object and the visual representation of the user of the second electronic device in the three-dimensional environment, the first electronic device receives a second indication of a request to associate the first object with a second surface, different from the first surface, in the three-dimensional environment. In some examples, in response to receiving the second indication, the first electronic device associates the first object with the second surface in the three-dimensional environment. In some examples, the first electronic device updates display, via the one or more displays, of the visual representation of the user of the second electronic device to be displayed at a second height, different from the first height, relative to the second surface in the three-dimensional environment from the viewpoint of the first electronic device.

Some examples of the disclosure are directed to systems and methods for moving virtual content vertically in a three-dimensional environment relative to a surface of the three-dimensional environment within a multi-user communication session. In some examples, a method is performed at a first electronic device in communication with one or more displays and one or more input devices. In some examples, while in a communication session with a second electronic device, the first electronic device displays, via the one or more displays, a visual representation of a user of the second electronic device and a first object corresponding to shared content in a three-dimensional environment, wherein the visual representation is displayed at a first height relative to a first surface in the three-dimensional environment from a viewpoint of the first electronic device. In some examples, while displaying the visual representation of the user of the second electronic device and the first object in the three-dimensional environment, the first electronic device detects, via the one or more input devices, a first input corresponding to a request to move the first object vertically in the three-dimensional environment relative to the viewpoint of the first electronic device. In some examples, in response to detecting the first input, the first electronic device moves the first object and the visual representation of the user of the second electronic device vertically in the three-dimensional environment relative to the viewpoint of the first electronic device in accordance with the first input. In some examples, the first electronic device displays, via the one or more displays, the visual representation of the user of the second electronic device at a second height, different from the first height, relative to the first surface in the three-dimensional environment.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a system according to some examples of the disclosure.

FIG. 3 illustrates an example of a spatial group in a multi-user communication session that includes a first electronic device and a second electronic device according to some examples of the disclosure.

FIGS. 4A-4I illustrate examples of presenting content in a three-dimensional environment relative to surfaces in the three-dimensional environment within a multi-user communication session according to some examples of the disclosure.

FIGS. 5A-5K illustrate examples of moving shared content vertically in a three-dimensional relative to surfaces in the three-dimensional environment within a multi-user communication session according to some examples of the disclosure.

FIG. 6 illustrates a flow diagram illustrating an example process for presenting content in a three-dimensional environment relative to surfaces in the three-dimensional environment within a multi-user communication session according to some examples of the disclosure.

FIG. 7 illustrates a flow diagram illustrating an example process for moving shared content virtually in a three-dimensional environment relative to surfaces in the three-dimensional environment within a multi-user communication session according to some examples of the disclosure.

### DETAILED DESCRIPTION

Some examples of the disclosure are directed to systems and methods for displaying virtual content relative to a surface of a three-dimensional environment within a multi-user communication session. In some examples, a method is performed at a first electronic device in communication with one or more displays and one or more input devices. In some examples, while in a communication session with a second electronic device and while displaying, via the one or more displays, a visual representation of a user of the second electronic device in a three-dimensional environment, wherein the visual representation is displayed at a first height relative to a first surface in the three-dimensional environment from a viewpoint of the first electronic device, the first electronic device receives a first indication of a request to share content of a first type in the communication session. In some examples, in response to receiving the first indication, the first electronic device displays, via the one or more displays, a first object corresponding to the content of the first type in the three-dimensional environment. In some examples, while displaying the first object and the visual representation of the user of the second electronic device in the three-dimensional environment, the first electronic device receives a second indication of a request to associate the first object with a second surface, different from the first surface, in the three-dimensional environment. In some examples, in response to receiving the second indication, the first electronic device associates the first object with the second surface in the three-dimensional environment. In some examples, the first electronic device updates display, via the one or more displays, of the visual representation of the user of the second electronic device to be displayed at a second height, different from the first height, relative to the second surface in the three-dimensional environment from the viewpoint of the first electronic device.

Some examples of the disclosure are directed to systems and methods for moving virtual content vertically in a three-dimensional environment relative to a surface of the three-dimensional environment within a multi-user communication session. In some examples, a method is performed at a first electronic device in communication with one or more displays and one or more input devices. In some examples, while in a communication session with a second electronic device, the first electronic device displays, via the one or more displays, a visual representation of a user of the second electronic device and a first object corresponding to shared content in a three-dimensional environment, wherein the visual representation is displayed at a first height relative to a first surface in the three-dimensional environment from a viewpoint of the first electronic device. In some examples, while displaying the visual representation of the user of the second electronic device and the first object in the three-dimensional environment, the first electronic device detects, via the one or more input devices, a first input corresponding to a request to move the first object vertically in the three-dimensional environment relative to the viewpoint of the first electronic device. In some examples, in response to detecting the first input, the first electronic device moves the first object and the visual representation of the user of the second electronic device vertically in the three-dimensional environment relative to the viewpoint of the first electronic device in accordance with the first input. In some examples, the first electronic device displays, via the one or more displays, the visual representation of the user of the second electronic device at a second height, different from the first height, relative to the first surface in the three-dimensional environment.

As used herein, a spatial group corresponds to a group or number of participants (e.g., users) in a multi-user communication session. In some examples, a spatial group in the multi-user communication session has a spatial arrangement that dictates locations of users and content that are located in the spatial group. In some examples, users in the same spatial group within the multi-user communication session experience spatial truth according to the spatial arrangement of the spatial group. In some examples, spatial truth requires a consistent spatial arrangement between users (or representations thereof) and virtual objects.

As used herein, movement of a shared virtual object within a multi-user communication session triggers spatial refinement in a shared three-dimensional environment of the multi-user communication session. In some examples, spatial refinement corresponds to movement and/or repositioning of avatars and/or shared objects (e.g., triggered by the movement of a shared object) that enables spatial truth to be maintained within a respective spatial group of users, as discussed in more detail below.

In some examples, initiating a multi-user communication session may include interaction with one or more user interface elements. In some examples, a user's gaze may be tracked by an electronic device as an input for targeting a selectable option/affordance within a respective user interface element that is displayed in the three-dimensional environment. For example, gaze can be used to identify one or more options/affordances targeted for selection using another selection input. In some examples, a respective option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

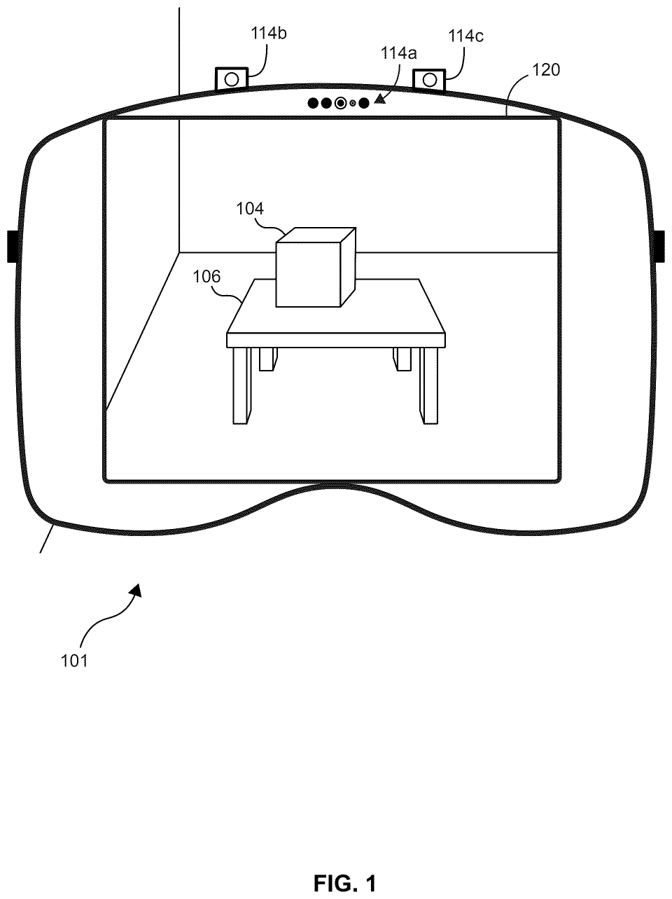

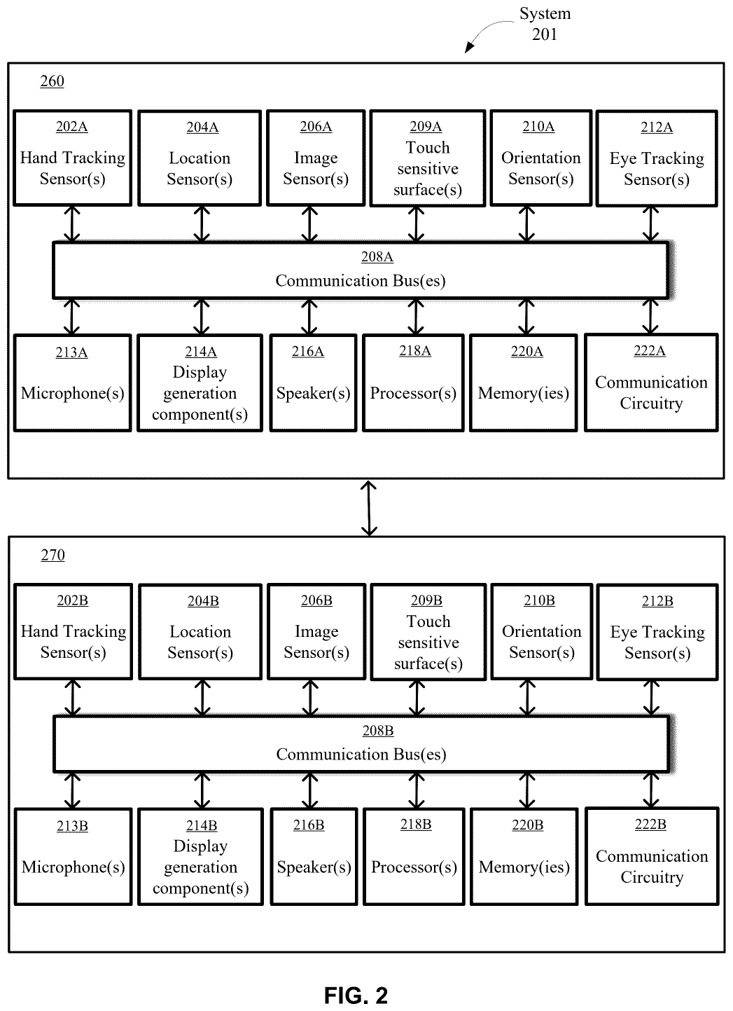

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a system 201 according to some examples of the disclosure. In some examples, system 201 includes multiple devices. For example, the system 201 includes a first electronic device 260 and a second electronic device 270, wherein the first electronic device 260 and the second electronic device 270 are in communication with each other. In some examples, the first electronic device 260 and the second electronic device 270 are a portable device, such as a mobile phone, smart phone, a tablet computer, a laptop computer, an auxiliary device in communication with another device, a head-mounted display, etc., respectively. In some examples, the first electronic device 260 and the second electronic device 270 correspond to electronic device 101 described above with reference to FIG. 1.

As illustrated in FIG. 2, the first electronic device 260 optionally includes various sensors (e.g., one or more hand tracking sensors 202A, one or more location sensors 204A, one or more image sensors 206A, one or more touch-sensitive surfaces 209A, one or more motion and/or orientation sensors 210A, one or more eye tracking sensors 212A, one or more microphones 213A or other audio sensors, one or more body tracking sensors (e.g., torso and/or head tracking sensors), one or more display generation components 214A, one or more speakers 216A, one or more processors 218A, one or more memories 220A, and/or communication circuitry 222A. In some examples, the second electronic device 270 optionally includes various sensors (e.g., one or more hand tracking sensors 202B, one or more location sensors 204B, one or more image sensors 206B, one or more touch-sensitive surfaces 209B, one or more motion and/or orientation sensors 210B, one or more eye tracking sensors 212B, one or more microphones 213B or other audio sensors, one or more body tracking sensors (e.g., torso and/or head tracking sensors), one or more display generation components 214B, one or more speakers 216, one or more processors 218B, one or more memories 220B, and/or communication circuitry 222B. In some examples, the one or more display generation components 214A, 214B correspond to display 120 in FIG. 1. One or more communication buses 208A and 208B are optionally used for communication between the above-mentioned components of electronic devices 260 and 270, respectively. First electronic device 260 and second electronic device 270 optionally communicate via a wired or wireless connection (e.g., via communication circuitry 222A, 222B) between the two devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A, 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 260 and 270 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with electronic devices 260 and 270, respectively, or external to electronic devices 260 and 270, respectively, that is in communication with electronic devices 260 and 270).

Electronic devices 260 and 270 optionally include image sensor(s) 206A and 206B, respectively. Image sensors(s) 206A/206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A/206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A/206B also optionally include one or more cameras configured to capture movement of physical objects in the real-world environment. Image sensor(s) 206A/206B also optionally include one or more depth sensors configured to detect the distance of physical objects from electronic device 260/270. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic devices 260 and 270 use CCD sensors, event cameras, and depth sensors in combination to detect the physical environment around electronic devices 260 and 270. In some examples, image sensor(s) 206A/206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 260/270 uses image sensor(s) 206A/206B to detect the position and orientation of electronic device 260/270 and/or display generation component(s) 214A/214B in the real-world environment. For example, electronic device 260/270 uses image sensor(s) 206A/206B to track the position and orientation of display generation component(s) 214A/214B relative to one or more fixed objects in the real-world environment.

In some examples, electronic device 260/270 includes microphone(s) 213A/213B or other audio sensors. Device 260/270 uses microphone(s) 213A/213B to detect sound from the user and/or the real-world environment of the user. In some examples, microphone(s) 213A/213B includes an array of microphones (a plurality of microphones) that optionally operate in tandem, such as to identify ambient noise or to locate the source of sound in space of the real-world environment.

In some examples, device 260/270 includes location sensor(s) 204A/204B for detecting a location of device 260/270 and/or display generation component(s) 214A/214B. For example, location sensor(s) 204A/204B can include a global positioning system (GPS) receiver that receives data from one or more satellites and allows electronic device 260/270 to determine the device's absolute position in the physical world.

In some examples, electronic device 260/270 includes orientation sensor(s) 210A/210B for detecting orientation and/or movement of electronic device 260/270 and/or display generation component(s) 214A/214B. For example, electronic device 260/270 uses orientation sensor(s) 210A/210B to track changes in the position and/or orientation of electronic device 260/270 and/or display generation component(s) 214A/214B, such as with respect to physical objects in the real-world environment. Orientation sensor(s) 210A/210B optionally include one or more gyroscopes and/or one or more accelerometers.

Electronic device 260/270 includes hand tracking sensor(s) 202A/202B and/or eye tracking sensor(s) 212A/212B (and/or other body tracking sensor(s), such as leg, torso, and/or head tracking sensor(s)), in some examples. Hand tracking sensor(s) 202A/202B are configured to track the position/location of one or more portions of the user's hands, and/or motions of one or more portions of the user's hands with respect to the extended reality environment, relative to the display generation component(s) 214A/214B, and/or relative to another defined coordinate system. Eye tracking sensor(s) 212A/212B are configured to track the position and movement of a user's gaze (eyes, face, or head, more generally) with respect to the real-world or extended reality environment and/or relative to the display generation component(s) 214A/214B. In some examples, hand tracking sensor(s) 202A/202B and/or eye tracking sensor(s) 212A/212B are implemented together with the display generation component(s) 214A/214B. In some examples, the hand tracking sensor(s) 202A/202B and/or eye tracking sensor(s) 212A/212B are implemented separate from the display generation component(s) 214A/214B.

In some examples, the hand tracking sensor(s) 202A/202B (and/or other body tracking sensor(s), such as leg, torso, and/or head tracking sensor(s)) can use image sensor(s) 206A/206B (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A/206B are positioned relative to the user to define a field of view of the image sensor(s) 206A/206B and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212A/212B includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 260/270 and system 201 are not limited to the components and configuration of FIG. 2, but can include fewer, other, or additional components in multiple configurations. In some examples, system 201 can be implemented in a single device. A person or persons using system 201, is optionally referred to herein as a user or users of the device(s). Attention is now directed towards exemplary concurrent displays of a three-dimensional environment on a first electronic device (e.g., corresponding to electronic device 260) and a second electronic device (e.g., corresponding to electronic device 270). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session. In some examples, interactions with content in the three-dimensional environment while the first electronic device and the second electronic device are in the multi-user communication session may cause the user of the first electronic device and the user of the second electronic device to become associated with different spatial groups in the multi-user communication session.

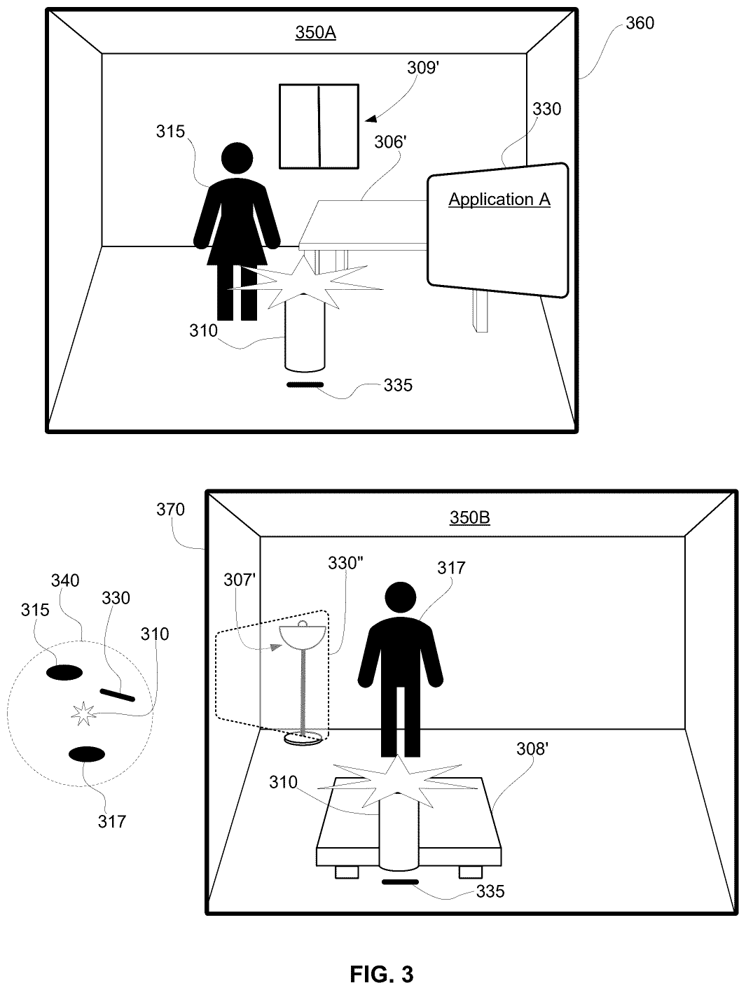

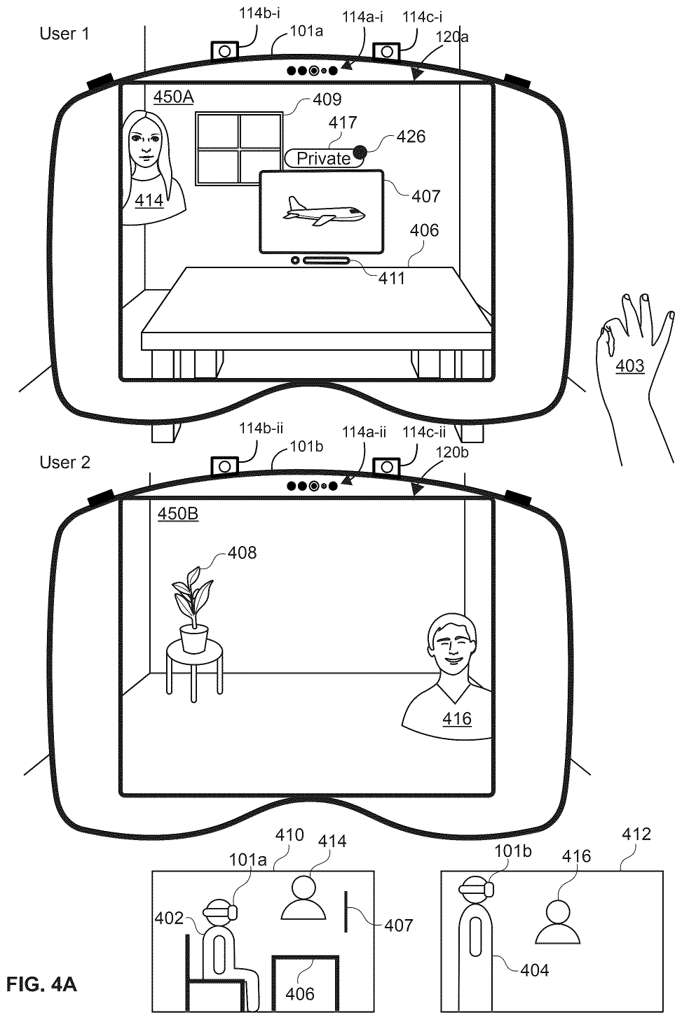

FIG. 3 illustrates an example of a spatial group 340 in a multi-user communication session that includes a first electronic device 360 and a second electronic device 370 according to some examples of the disclosure. In some examples, the first electronic device 360 may present a three-dimensional environment 350A, and the second electronic device 370 may present a three-dimensional environment 350B. The first electronic device 360 and the second electronic device 370 may be similar to electronic device 101 or 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user is optionally wearing the first electronic device 360 and a second user is optionally wearing the second electronic device 370, such that the three-dimensional environment 350A/350B can be defined by X, Y and Z axes as viewed from a perspective of the electronic devices (e.g., a viewpoint associated with the electronic device 360/370, which may be a head-mounted display, for example).

As shown in FIG. 3, the first electronic device 360 may be in a first physical environment that includes a table 306 and a window 309. Thus, the three-dimensional environment 350A presented using the first electronic device 360 optionally includes captured portions of the physical environment surrounding the first electronic device 360, such as a representation of the table 306′ and a representation of the window 309′. Similarly, the second electronic device 370 may be in a second physical environment, different from the first physical environment (e.g., separate from the first physical environment), that includes a floor lamp 307 and a coffee table 308. Thus, the three-dimensional environment 350B presented using the second electronic device 370 optionally includes captured portions of the physical environment surrounding the second electronic device 370, such as a representation of the floor lamp 307′ and a representation of the coffee table 308′. Additionally, the three-dimensional environments 350A and 350B may include representations of the floor, ceiling, and walls of the room in which the first electronic device 360 and the second electronic device 370, respectively, are located.

As mentioned above, in some examples, the first electronic device 360 is optionally in a multi-user communication session with the second electronic device 370. For example, the first electronic device 360 and the second electronic device 370 (e.g., via communication circuitry 222A/222B) are configured to present a shared three-dimensional environment 350A/350B that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at two or more electronic devices via which content, applications, data, and the like may be shared and/or presented to users of the two or more electronic devices. In some examples, while the first electronic device 360 is in the multi-user communication session with the second electronic device 370, an avatar corresponding to the user of one electronic device is optionally displayed in the three-dimensional environment that is displayed via the other electronic device. For example, as shown in FIG. 3, at the first electronic device 360, an avatar 315 corresponding to the user of the second electronic device 370 is displayed in the three-dimensional environment 350A. Similarly, at the second electronic device 370, an avatar 317 corresponding to the user of the first electronic device 360 is displayed in the three-dimensional environment 350B.

In some examples, the presentation of avatars 315/317 as part of a shared three-dimensional environment is optionally accompanied by an audio effect corresponding to a voice of the users of the electronic devices 370/360. For example, the avatar 315 displayed in the three-dimensional environment 350A using the first electronic device 360 is optionally accompanied by an audio effect corresponding to the voice of the user of the second electronic device 370. In some such examples, when the user of the second electronic device 370 speaks, the voice of the user may be detected by the second electronic device 370 (e.g., via the microphone(s) 213B) and transmitted to the first electronic device 360 (e.g., via the communication circuitry 222B/222A), such that the detected voice of the user of the second electronic device 370 may be presented as audio (e.g., using speaker(s) 216A) to the user of the first electronic device 360 in three-dimensional environment 350A. In some examples, the audio effect corresponding to the voice of the user of the second electronic device 370 may be spatialized such that it appears to the user of the first electronic device 360 to emanate from the location of avatar 315 in the shared three-dimensional environment 350A (e.g., despite being outputted from the speakers of the first electronic device 360). Similarly, the avatar 317 displayed in the three-dimensional environment 350B using the second electronic device 370 is optionally accompanied by an audio effect corresponding to the voice of the user of the first electronic device 360. In some such examples, when the user of the first electronic device 360 speaks, the voice of the user may be detected by the first electronic device 360 (e.g., via the microphone(s) 213A) and transmitted to the second electronic device 370 (e.g., via the communication circuitry 222A/222B), such that the detected voice of the user of the first electronic device 360 may be presented as audio (e.g., using speaker(s) 216B) to the user of the second electronic device 370 in three-dimensional environment 350B. In some examples, the audio effect corresponding to the voice of the user of the first electronic device 360 may be spatialized such that it appears to the user of the second electronic device 370 to emanate from the location of avatar 317 in the shared three-dimensional environment 350B (e.g., despite being outputted from the speakers of the first electronic device 360).

In some examples, while in the multi-user communication session, the avatars 315/317 are displayed in the three-dimensional environments 350A/350B with respective orientations that correspond to and/or are based on orientations of the electronic devices 360/370 (and/or the users of electronic devices 360/370) in the physical environments surrounding the electronic devices 360/370. For example, as shown in FIG. 3, in the three-dimensional environment 350A, the avatar 315 is optionally facing toward the viewpoint of the user of the first electronic device 360, and in the three-dimensional environment 350B, the avatar 317 is optionally facing toward the viewpoint of the user of the second electronic device 370. As a particular user moves the electronic device (and/or themself) in the physical environment, the viewpoint of the user changes in accordance with the movement, which may thus also change an orientation of the user's avatar in the three-dimensional environment. For example, with reference to FIG. 3, if the user of the first electronic device 360 were to look leftward in the three-dimensional environment 350A such that the first electronic device 360 is rotated (e.g., a corresponding amount) to the left (e.g., counterclockwise), the user of the second electronic device 370 would see the avatar 317 corresponding to the user of the first electronic device 360 rotate to the right (e.g., clockwise) relative to the viewpoint of the user of the second electronic device 370 in accordance with the movement of the first electronic device 360.

Additionally, in some examples, while in the multi-user communication session, a viewpoint of the three-dimensional environments 350A/350B and/or a location of the viewpoint of the three-dimensional environments 350A/350B optionally changes in accordance with movement of the electronic devices 360/370 (e.g., by the users of the electronic devices 360/370). For example, while in the communication session, if the first electronic device 360 is moved closer toward the representation of the table 306′ and/or the avatar 315 (e.g., because the user of the first electronic device 360 moved forward in the physical environment surrounding the first electronic device 360), the viewpoint of the three-dimensional environment 350A would change accordingly, such that the representation of the table 306′, the representation of the window 309′ and the avatar 315 appear larger in the field of view. In some examples, each user may independently interact with the three-dimensional environment 350A/350B, such that changes in viewpoints of the three-dimensional environment 350A and/or interactions with virtual objects in the three-dimensional environment 350A by the first electronic device 360 optionally do not affect what is shown in the three-dimensional environment 350B at the second electronic device 370, and vice versa.

In some examples, the avatars 315/317 are representations (e.g., a full-body rendering) of the users of the electronic devices 370/360. In some examples, the avatar 315/317 is a representation of a portion (e.g., a rendering of a head, face, head and torso, etc.) of the users of the electronic devices 370/360. In some examples, the avatars 315/317 are user-personalized, user-selected, and/or user-created representations displayed in the three-dimensional environments 350A/350B that are representative of the users of the electronic devices 370/360. It should be understood that, while the avatars 315/317 illustrated in FIG. 3 correspond to full-body representations of the users of the electronic devices 370/360, respectively, alternative avatars may be provided, such as those described above.

As mentioned above, while the first electronic device 360 and the second electronic device 370 are in the multi-user communication session, the three-dimensional environments 350A/350B may be a shared three-dimensional environment that is presented using the electronic devices 360/370. In some examples, content that is viewed by one user at one electronic device may be shared with another user at another electronic device in the multi-user communication session. In some such examples, the content may be experienced (e.g., viewed and/or interacted with) by both users (e.g., via their respective electronic devices) in the shared three-dimensional environment. For example, as shown in FIG. 3, the three-dimensional environments 350A/350B include a shared virtual object 310 (e.g., which is optionally a three-dimensional virtual sculpture) that is viewable by and interactive to both users. As shown in FIG. 3, the shared virtual object 310 may be displayed with a grabber affordance (e.g., a handlebar) 335 that is selectable to initiate movement of the shared virtual object 310 within the three-dimensional environments 350A/350B.

In some examples, the three-dimensional environments 350A/350B include unshared content that is private to one user in the multi-user communication session. For example, in FIG. 3, the first electronic device 360 is displaying a private application window 330 in the three-dimensional environment 350A, which is optionally an object that is not shared between the first electronic device 360 and the second electronic device 370 in the multi-user communication session. In some examples, the private application window 330 may be associated with a respective application that is operating on the first electronic device 360 (e.g., such as a media player application, a web browsing application, a messaging application, etc.). Because the private application window 330 is not shared with the second electronic device 370, the second electronic device 370 optionally displays a representation of the private application window 330″ in three-dimensional environment 350B. As shown in FIG. 3, in some examples, the representation of the private application window 330″ may be a faded, occluded, discolored, and/or translucent representation of the private application window 330 that prevents the user of the second electronic device 370 from viewing contents of the private application window 330.

As mentioned previously above, in some examples, the user of the first electronic device 360 and the user of the second electronic device 370 are in a spatial group 340 within the multi-user communication session. In some examples, the spatial group 340 may be a baseline (e.g., a first or default) spatial group within the multi-user communication session. For example, when the user of the first electronic device 360 and the user of the second electronic device 370 initially join the multi-user communication session, the user of the first electronic device 360 and the user of the second electronic device 370 are automatically (and initially, as discussed in more detail below) associated with (e.g., grouped into) the spatial group 340 within the multi-user communication session. In some examples, while the users are in the spatial group 340 as shown in FIG. 3, the user of the first electronic device 360 and the user of the second electronic device 370 have a first spatial arrangement (e.g., first spatial template) within the shared three-dimensional environment. For example, the user of the first electronic device 360 and the user of the second electronic device 370, including objects that are displayed in the shared three-dimensional environment, have spatial truth within the spatial group 340. In some examples, spatial truth requires a consistent spatial arrangement between users (or representations thereof) and virtual objects. For example, a distance between the viewpoint of the user of the first electronic device 360 and the avatar 315 corresponding to the user of the second electronic device 370 may be the same as a distance between the viewpoint of the user of the second electronic device 370 and the avatar 317 corresponding to the user of the first electronic device 360. As described herein, if the location of the viewpoint of the user of the first electronic device 360 moves, the avatar 317 corresponding to the user of the first electronic device 360 moves in the three-dimensional environment 350B in accordance with the movement of the location of the viewpoint of the user relative to the viewpoint of the user of the second electronic device 370. Additionally, if the user of the first electronic device 360 performs an interaction on the shared virtual object 310 (e.g., moves the virtual object 310 in the three-dimensional environment 350A), the second electronic device 370 alters display of the shared virtual object 310 in the three-dimensional environment 350B in accordance with the interaction (e.g., moves the virtual object 310 in the three-dimensional environment 350B).

It should be understood that, in some examples, more than two electronic devices may be communicatively linked in a multi-user communication session. For example, in a situation in which three electronic devices are communicatively linked in a multi-user communication session, a first electronic device would display two avatars, rather than just one avatar, corresponding to the users of the other two electronic devices. It should therefore be understood that the various processes and exemplary interactions described herein with reference to the first electronic device 360 and the second electronic device 370 in the multi-user communication session optionally apply to situations in which more than two electronic devices are communicatively linked in a multi-user communication session.

In some examples, it may be advantageous to provide mechanisms for presenting content in a three-dimensional environment relative to surfaces in the three-dimensional environment within a multi-user communication session. For example, it may be desirable to share virtual content in a three-dimensional environment that is optionally viewable by and/or interactive to users in the multi-user communication session in such a way that accommodates differing heights of the users in the multi-user communication session. As similarly discussed above, the three-dimensional environment optionally includes avatars corresponding to the users of the electronic devices in the multi-user communication session. In some examples, as discussed below, the presentation of virtual objects (e.g., avatars and shared virtual content) in the three-dimensional environment within a multi-user communication session is selected to be relative to a physical surface in a physical environment and/or relative to a virtual surface of the three-dimensional environment to enable the virtual objects to be clearly and easily viewable and/or interactive relative to the different heights of the viewpoints associated with the users in the multi-user communication session.

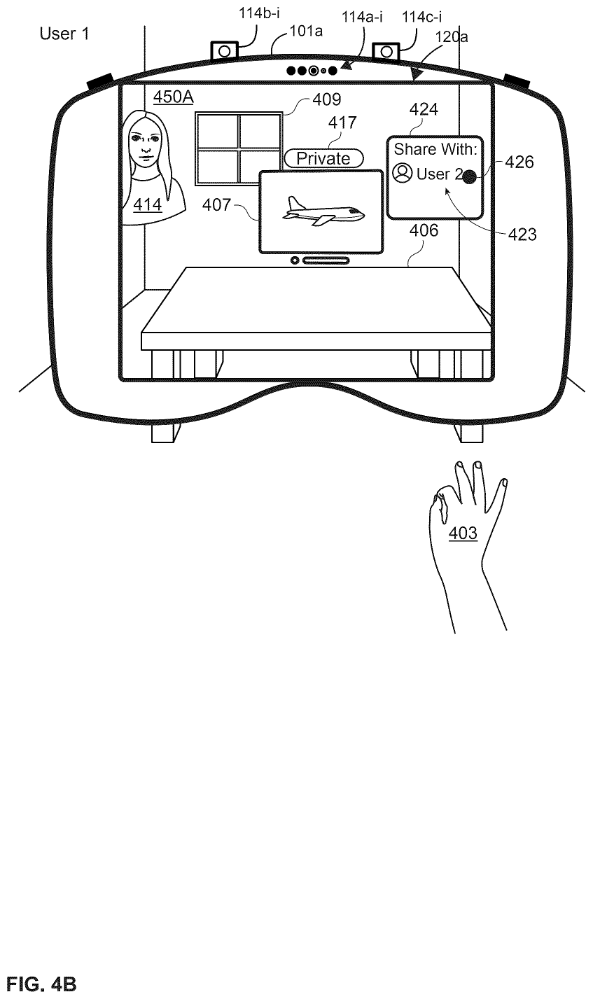

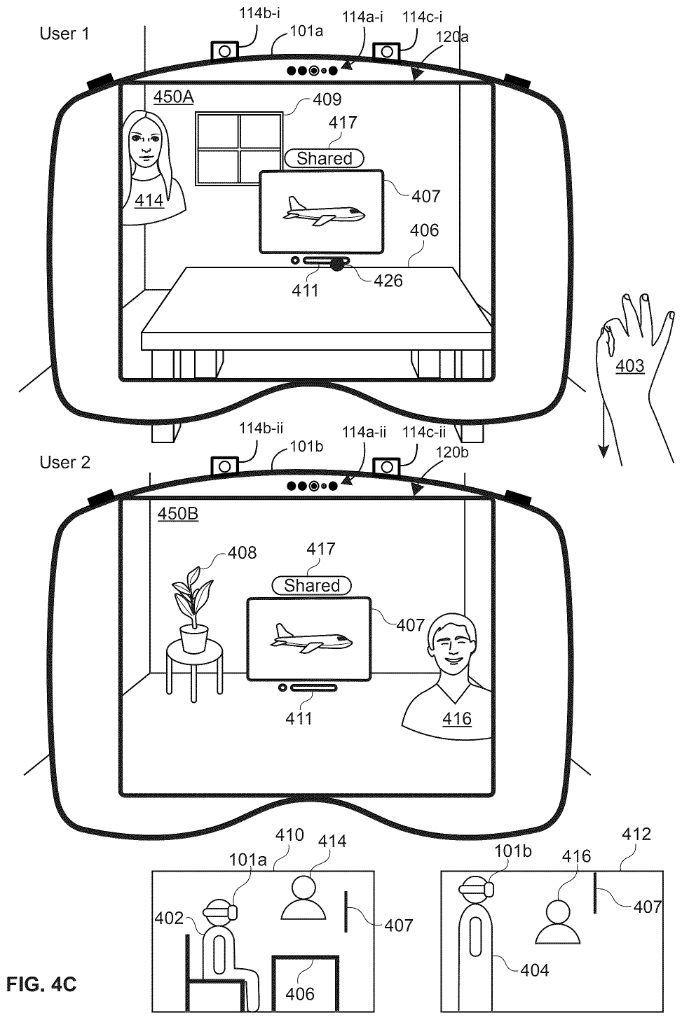

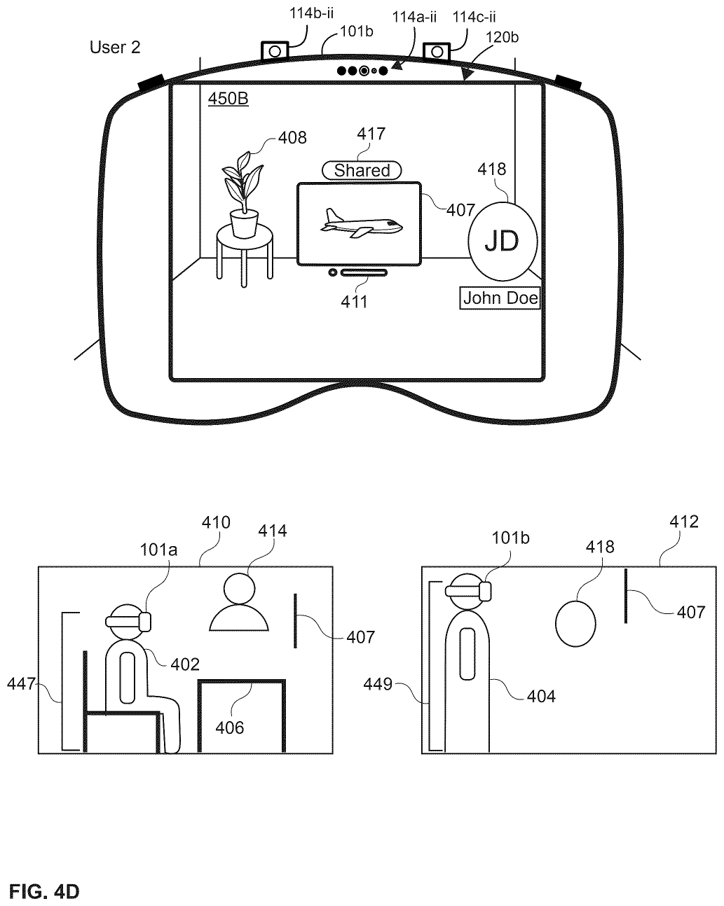

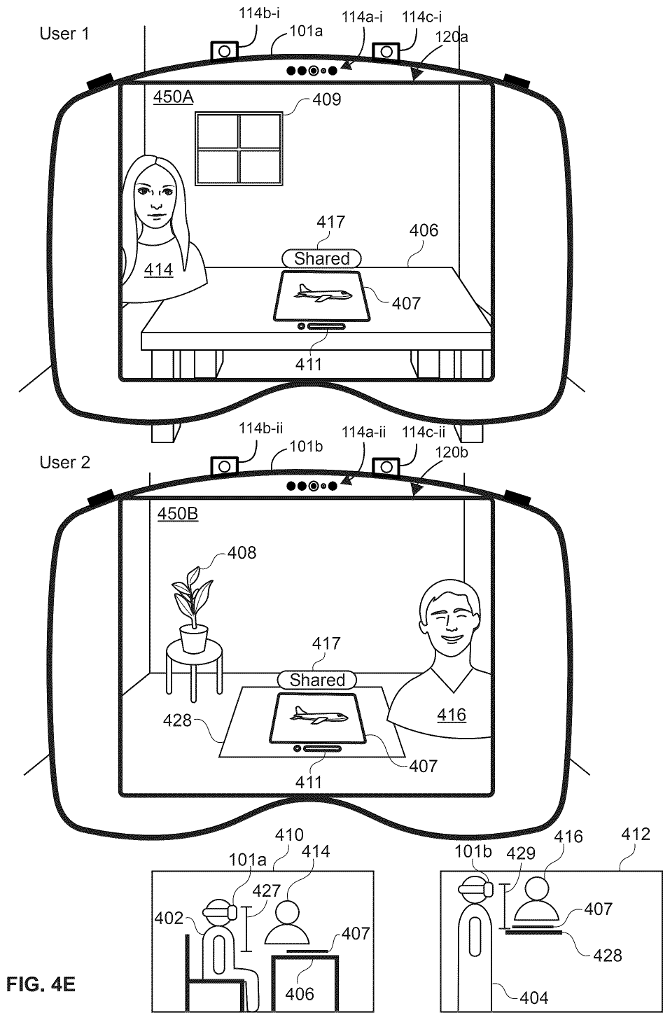

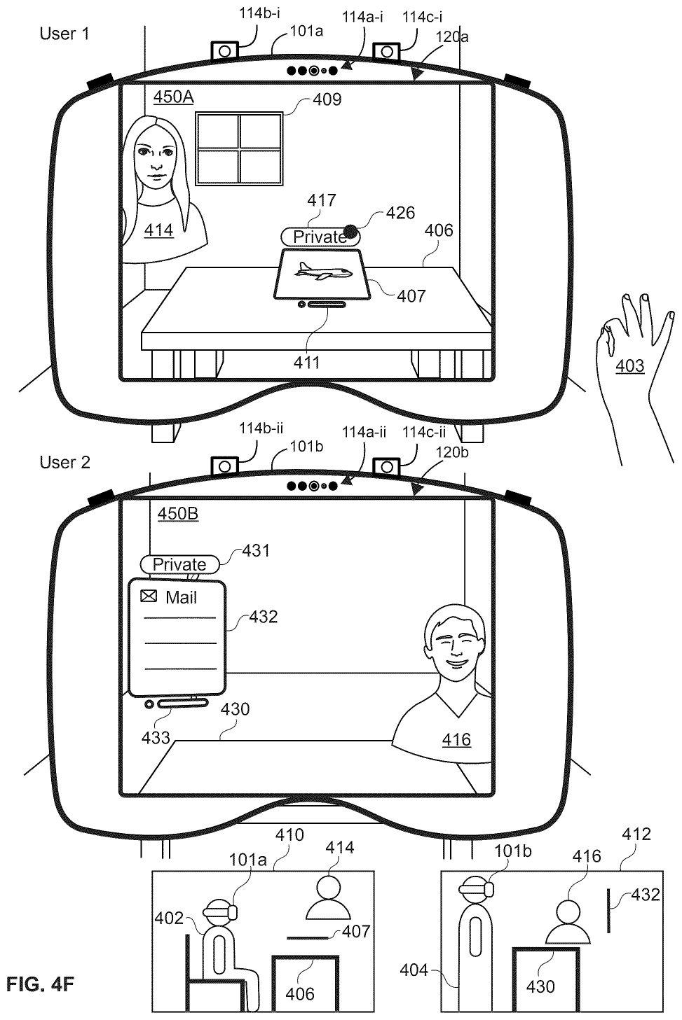

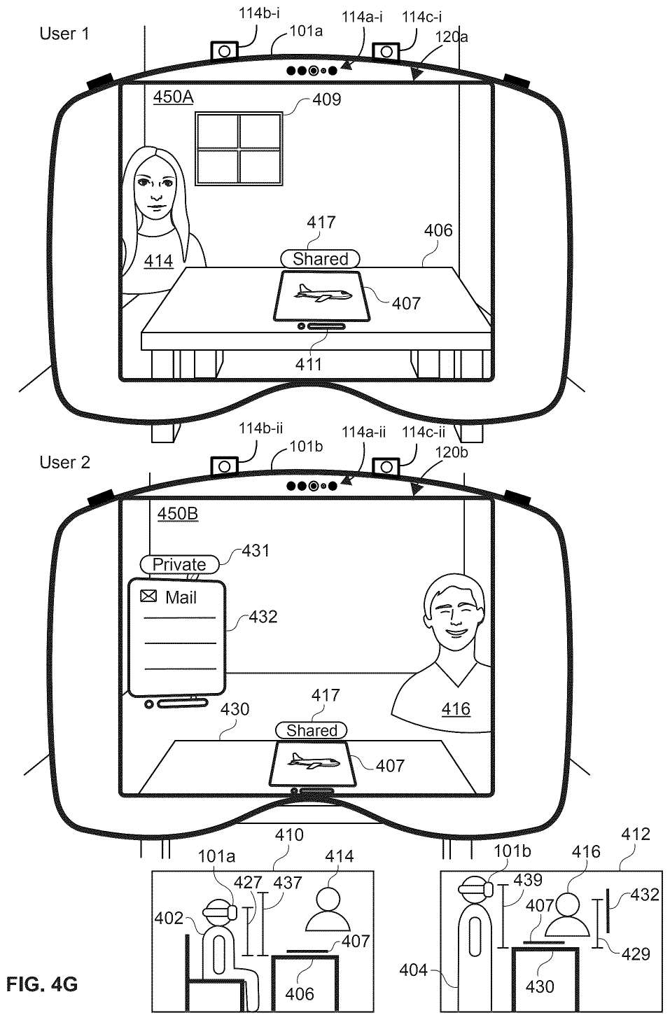

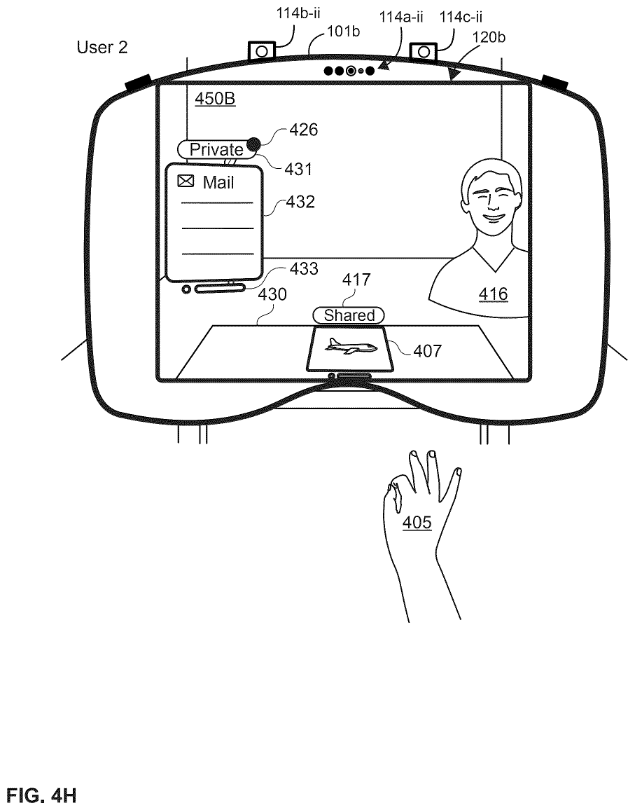

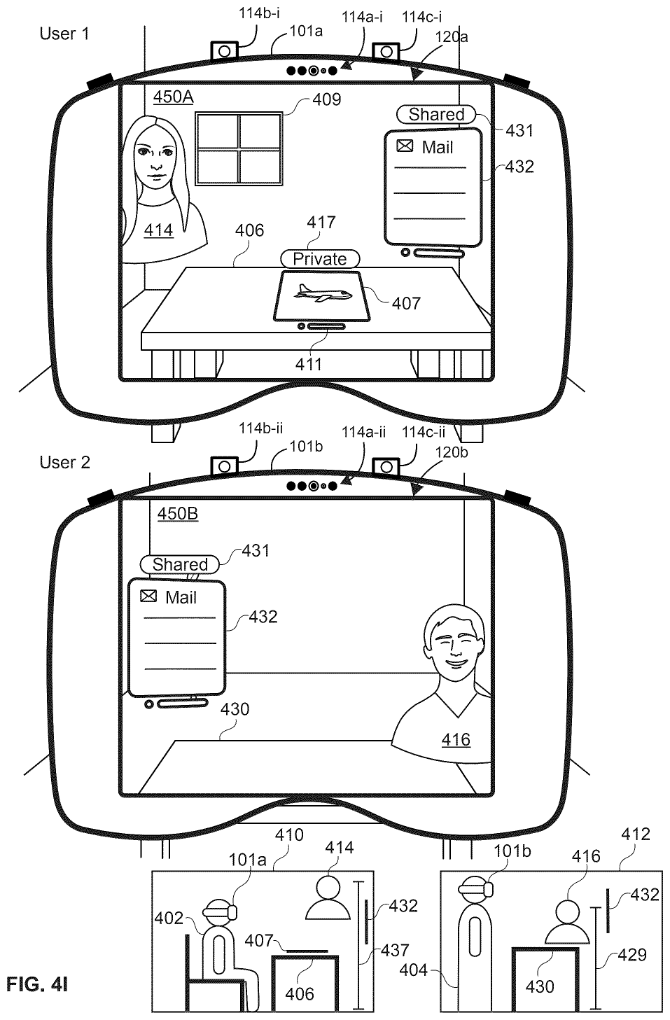

FIGS. 4A-4I illustrate examples of presenting content in a three-dimensional environment relative to surfaces in the three-dimensional environment within a multi-user communication session according to some examples of the disclosure. In some examples, while a first electronic device 101a is in a multi-user communication session with a second electronic device 101b, three-dimensional environment 450A is presented using the first electronic device 101a (e.g., via display 120a) and three-dimensional environment 450B is presented using the second electronic device 101b (e.g., via display 120b). In some examples, the electronic devices 101a/101b optionally correspond to or are similar to electronic devices 360/370 discussed above and/or electronic devices 260/270 in FIG. 2. In some examples, as shown in FIG. 4A, the first electronic device 101a is being used by (e.g., worn on a head of) a first user 402 in side view 410 and the second electronic device 101b is being used by (e.g., worn on a head of) a second user 404 in side view 412.

In some examples, the three-dimensional environments 450A/450B include captured portions of the physical environments in which the electronic devices 101a/101b are located. For example, as shown in FIG. 4A, the physical environment of the first electronic device 101a includes desk 406 and window 409. Accordingly, in some examples, the three-dimensional environment 450A includes the desk 406 (e.g., a representation of the desk) and the window 409 (e.g., a representation of the window 409). Similarly, as shown in FIG. 4A, the physical environment of the second electronic device 101b includes houseplant 408. Accordingly, in some examples, as shown in FIG. 4A, the three-dimensional environment 450B includes the houseplant 408 (e.g., a representation of the houseplant). In some examples, the representations can include portions of the physical environments viewed through a transparent or translucent display of the first electronic device 101a and the second electronic device 101b. In some examples, the three-dimensional environments 450A/450B have one or more characteristics of the three-dimensional environments 350A/350B described above with reference to FIG. 3.

As described above with reference to FIG. 3, while electronic devices are communicatively linked in a multi-user communication session, users may be represented by avatars corresponding to the users of the electronic devices. For example, as shown in FIG. 4A, the three-dimensional environment 450A presented at the first electronic device 101a includes avatar 414 corresponding to the second user 404 (e.g., a three-dimensional visual representation of the second user 404), and the three-dimensional environment 450B presented at the second electronic device 101b includes avatar 416 corresponding to the first user 402 (e.g., a three-dimensional visual representation of the first user 402). Additionally, in some examples, as similarly described above with reference to FIG. 3, while electronic devices are communicatively linked in a multi-user communication session, virtual content (e.g., user interfaces, three-dimensional shapes or models, interactive virtual video games, etc.) is configured to be displayed and/or shared among the users of the electronic devices. For example, in FIG. 4A, the first electronic device 101a is displaying virtual object 407, which optionally is or includes a user interface including content (e.g., a two-dimensional image of an airplane). In some examples, as shown in FIG. 4A, the virtual object 407 includes or is displayed with grabber or handlebar 411 that is selectable to initiate movement of the virtual object 407 in the three-dimensional environment 450A relative to the viewpoint of the first electronic device 101a. In some examples, as indicated in FIG. 4A, the virtual object 407 corresponds to a private virtual object within the multi-user communication session. For example, as shown in FIG. 4A, the virtual object 407 includes or is displayed with pill 417 indicating that the virtual object 407 is currently a private virtual object (e.g., a virtual object that is viewable by and/or interactive to only the first user 402 at the first electronic device 101a, as similarly discussed above with reference to FIG. 3). In some examples, the pill 417 is selectable to initiate a process to change a privacy status of the virtual object 407, including sharing the virtual object 407 with other users in the multi-user communication session.

As similarly described above with reference to FIG. 3, while the first electronic device 101a is in the multi-user communication session with the second electronic device 101b, the first user 402 and the second user 404 may be in a first spatial group within the multi-user communication session In some examples, the first spatial group has one or more characteristics of spatial group 340 discussed above with reference to FIG. 3. As similarly described above, while the first user 402 and the second user 404 are in the first spatial group within the multi-user communication session, the users have a first spatial arrangement in the shared three-dimensional environment (e.g., represented by the locations of and/or distance between the users 402 and 404 in the side views 410/412 in FIG. 4A) determined by the physical locations of the first electronic device 101a and the second electronic device 101b in their respective physical environments. Particularly, the first electronic device 101a and the second electronic device 101b experience spatial truth within the first spatial group as dictated by the physical locations of and/or orientations of the first user 402 and the second user 404, respectively.

In some examples, as discussed herein, the avatars 414/416 are displayed with respective heights that are based on respective heights associated with the users of the electronic devices 101a/101b. In some examples, the heights of the users are determined by the electronic devices 101a/101b as being relative to a floor or ground of the three-dimensional environments 450A/450B (e.g., the floors of the physical environments in which the electronic devices 101a/101b are located). In some examples, a height of a respective user corresponds to a vertical distance between the floor or ground and the electronic device associated with (e.g., worn by) the respective user. For example, in the side view 410, a height of the first user 402 is determined to be a vertical distance between the floor of the physical environment of the first user 402 and the first electronic device 101a (e.g., which is worn on the head of the first user 402), despite the first user 402 being situated within a chair in front of the desk 406. Similarly, in the side view 412, a height of the second user 404 is determined to be a vertical distance between the floor of the physical environment of the second user 404 and the second electronic device 101b (e.g., which is worn on the head of the second user 404). As mentioned above, in some examples, a height of a respective avatar is based on (e.g., corresponds to and/or is equal to) a determined height of the corresponding user relative to the floor or ground of the three-dimensional environment. For example, as illustrated in the side view 410 in FIG. 4A, a height of the avatar 414 corresponds to the height of the second user 404 (e.g., height 449 in the side view 412 in FIG. 4D), and in the side view 412, a height of the avatar 416 corresponds to the height of the first user 402 (e.g., height 447 in the side view 410 in FIG. 4D) relative to the floor or ground of their respective physical environments.

In some instances, it may be desirable and/or advantageous to redisplay the avatars corresponding to users in a multi-user communication session relative to alternative surfaces in the three-dimensional environment (e.g., surfaces different from the floor or ground of the respective physical environments of the users). Particularly, in some examples, it may be desirable to reposition avatars relative to alternative surfaces in the three-dimensional environment to enable the avatars to be at or near eye level with users at their respective electronic devices, such as when users are viewing and/or interacting with shared content (e.g., horizontally oriented content, as discussed below).

In FIG. 4A, while the first electronic device 101a is in the multi-user communication session with the second electronic device 110b, the first electronic device 101a detects an input corresponding to a request to change a privacy status of the virtual object 407 in the three-dimensional environment 450A. For example, as shown in FIG. 4A, the first electronic device 101a detects a selection input directed to the pill 417, such as an air pinch gesture (e.g., contact between the index finger and thumb) performed by hand 403 of the first user 402, optionally while gaze 426 of the first user 402 is directed to the pill 417 in the three-dimensional environment 450A. It should be understood that additional or alternative inputs are possible, such as air tap gestures, gaze and dwell inputs, verbal commands, etc.

In some examples, as shown in FIG. 4B, in response to detecting the selection of the pill 417, the first electronic device 101a displays menu element 424 in the three-dimensional environment 450A. For example, as shown in FIG. 4B, the first electronic device 101a displays the menu element 424 that includes one or more options for sharing the content of the virtual object 407 within the multi-user communication session (e.g., which allows other users in the multi-user communication session to view and/or interact with the content of the virtual object 407). In FIG. 4B, while displaying the menu element 424, the first electronic device 101a detects a selection of option 423 in the menu element 424 in the three-dimensional environment 450A. For example, as shown in FIG. 4B, the first electronic device 101a detects an air pinch gesture performed by the hand 403, optionally while the gaze 426 of the first user 402 is directed to the option 423 in the three-dimensional environment 450A.

In some examples, as shown in FIG. 4C, in response to detecting the selection of the option 423 in the menu element 424, the first electronic device 101a shares the virtual object 407 in the multi-user communication session. For example, as indicated by the pill 417 in FIG. 4C, the virtual object 407 becomes a shared virtual object within the multi-user communication session, such that the content of the virtual object 407 is now also viewably by and/or interactive to the second user 404 at the second electronic device 101b. In some examples, as shown in FIG. 4C, when the virtual object 407 is shared with the second electronic device 101b, the second electronic device 101b updates display of the three-dimensional environment 450B to include the virtual object 407. Additionally, in some examples, as shown in the side views 410 and 412 in FIG. 4C, when the virtual object 407 is shared in the multi-user communication session, the first electronic device 101a maintains display of the avatar 414 (e.g., at the same height in the three-dimensional environment 450A relative to the floor) and the second electronic device 101b maintains display of the avatar 416 (e.g., at the same height in the three-dimensional environment 450B relative to the floor).

In FIG. 4C, the first electronic device 101a detects an input corresponding to a request to associate the virtual object 407 with a respective surface in the three-dimensional environment 450A (e.g., a surface that is different from the surface of the floor or ground of the physical environment of the first electronic device 101a). In some examples, the input corresponding to the request to associate the virtual object 407 with the respective surface includes and/or corresponds to a movement input directed to the virtual object 407. For example, as shown in FIG. 4C, the first electronic device 101a detects an air pinch and drag gesture provided by the hand 403, optionally while the gaze 426 is directed to the grabber 411 associated with the virtual object 407. In some examples, as indicated in FIG. 4C, the air pinch and drag gesture includes movement of the hand 403 toward the viewpoint of the first electronic device 101a and toward a top surface of the desk 406 (e.g., the representation of the desk) in the three-dimensional environment 450A. Accordingly, in some examples, the input corresponding to the request to associate the virtual object 407 with a respective surface in the three-dimensional environment 450A corresponds to a request to display (e.g., and/or anchor) the virtual object 407 to the surface of the desk 406 in the three-dimensional environment 450A.

In some examples, while the first electronic device 101a is detecting the air pinch and drag gesture directed to the virtual object 407 provided by the hand 403 of the first user 402, the second electronic device 101b updates display of the avatar 416 corresponding to the first user 402 in the three-dimensional environment 450B. For example, as shown in FIG. 4D, the second electronic device 101b replaces the avatar 416 with a two-dimensional representation of the first user 402, such as spatial coin 418, in the three-dimensional environment 450B. In some examples, as shown in FIG. 4D, the spatial coin 418 includes an indication of a name of the first user 402 (e.g., John Doc) and a two-dimensional visual representation (e.g., image, photograph, icon, cartoon, sketch, etc.) of the first user 402. In some examples, the spatial coin 418 provides a visual indication to the second user 404 that the first user 402 is interacting with the virtual object 407 (e.g., is moving the virtual object 407 as described above). In some examples, the first electronic device 101a transmits an indication of the input provided by the first user 402 to the second electronic device 101b when the input is detected by the first electronic device 101a, which enables and/or causes the second electronic device 101b to update display of the visual representation of the first user 402 in the three-dimensional environment 450B (e.g., from the three-dimensional avatar to the two-dimensional spatial coin).

In some examples, when the first electronic device 101a associates the virtual object 407 with the surface of the desk 406 in the three-dimensional environment 450A, the first electronic device 101a and the second electronic device 101b update the heights at which the avatars 414 and 416 are displayed in their respective three-dimensional environments. Particularly, the first electronic device 101a updates the height of the avatar 414 in the three-dimensional environment 450A to no longer correspond to height 449 of the second user 404 relative to the floor, indicated in the side view 412 in FIG. 4D, and the second electronic device 101b updates the height of the avatar 416 in the three-dimensional environment 450B to no longer correspond to height 447 of the first user 402 relative to the floor, indicated in the side view 410, as described in more detail below.

In some examples, the association of the virtual object 407 with the surface of the desk 406 in the three-dimensional environment 450A causes the heights of the avatars 414/416 to be updated in their respective three-dimensional environments because the virtual object 407 corresponds to and/or is a virtual object of a first type when associated with the surface of the desk 406 (e.g., when displayed on the surface of the desk 406). In some examples, an object of the first type corresponds to a virtual object that is or includes horizontally oriented content. For example, as shown in FIG. 4E, the virtual object 407 is displayed atop the surface of the desk 406, such that the content (e.g., the image of the airplane) of the virtual object 407 has a horizontal orientation relative to the viewpoint of the first electronic device 101a that aligns with the horizontal (e.g., flat) orientation of the surface of the desk 406, as illustrated in the side view 410.

In some examples, when the virtual object 407 is moved to and displayed on the surface of the desk 406, such that the virtual object 407 has a horizontal orientation as discussed above in the three-dimensional environment 450A, the first electronic device 101a updates the manner in which the height of the first user 402 is measured in the physical environment of the first electronic device 101a. Particularly, in FIG. 4E, the first electronic device 101a determines the height of the first user 402 as being relative to the surface of the desk 406, rather than the surface of the floor of the physical environment of the first electronic device 101a, as indicated by height 427 in the side view 410. For example, the height 427 of the first user 402 is measured vertically between the first electronic device 101a and the surface of the desk 406 (e.g., as detected by one or more sensors (e.g., image sensors) of the first electronic device 101a). As an example, the height 427 in the side view 410 in FIG. 4E is different from (e.g., smaller than) the height 447 in the side view 410 in FIG. 4D. In some examples, as discussed below, the first electronic device 101a transmits data to the second electronic device 101b corresponding to the updated height 427 of the first user 402 that is relative to the surface of the desk 406 in the physical environment of the first electronic device 101a.

In some examples, because the physical environment of the second electronic device 101b does not include a surface other than the floor or ground of the physical environment and/or does not include a surface that is similar to the desk 406 that is in the physical environment of the first electronic device 101a, the second electronic device 101b generates a virtual surface 428 on which the virtual object 407 is displayed (e.g., anchored to) in the three-dimensional environment 450B after the virtual object 407 is displayed on (e.g., anchored to) the surface of the desk 406 in the three-dimensional environment 450A at the first electronic device 101a. In some examples, the virtual surface 428 in the three-dimensional environment 450B is similar to the surface of the desk 406 in the three-dimensional environment 450A. For example, the virtual surface 428 has a same or similar orientation as the surface of the desk 406 (e.g., a horizontal orientation relative to the viewpoints of the electronic devices 101a/101b). Additionally or alternatively, in some examples, the virtual surface 428 has a same or similar size as the surface of the desk 406 (e.g., a same or similar surface area on which content is able to be displayed). In some examples, a height of the virtual surface 428 relative to the viewpoint of the second electronic device 101b in the three-dimensional environment 450B is the same as or similar to a height of the surface of the desk 406 relative to the viewpoint of the first electronic device 101a in the three-dimensional environment 450A. For example, as illustrated in the side view 412 in FIG. 4E, a height 429 at which the virtual surface 428 is displayed in the three-dimensional environment 450B relative to the viewpoint of the second electronic device 101b corresponds to (e.g., is the same as) the height 427 in the side view 410.

In some examples, the second electronic device 101b additionally or alternatively generates and displays the virtual surface 428 in the three-dimensional environment 450B based on one or more physical properties of the physical environment in which the second electronic device 101b is located. For example, the second electronic device 101b determines a size, shape, orientation, and/or height of the virtual surface 428 relative to the viewpoint of the second electronic device 101b in the three-dimensional environment 450B based on a size of the physical environment of the second electronic device 101b and/or locations, sizes, and/or orientations of physical objects in the physical environment (e.g., the houseplant 408) as viewed in the field of view from the viewpoint of the second electronic device 101b. As an example, in FIG. 4E, the virtual surface 428 is positioned spatially in the three-dimensional environment 450B relative to the viewpoint of the second electronic device 101b to not correspond to (e.g., overlap and/or intersect) a location of the houseplant 408 in the three-dimensional environment 450B. In some examples, the virtual surface 428 is positioned in a center of the field of view of the second electronic device 101b from the viewpoint of the second electronic device 101b. In some examples, the virtual surface 428 is positioned at a predefined (e.g., determined without user input) height relative to the viewpoint of the second electronic device 101b in the three-dimensional environment 450B (e.g., and optionally irrespective of the height 427 of the first user 402 relative to the surface of the desk 406 in the side view 410).

As mentioned above, in some examples, when the virtual object 407 becomes associated with the surface of the desk 406 in the three-dimensional environment 450A (e.g., when the movement of the virtual object 407 to the surface of the desk 406 concludes), the second electronic device 101b redisplays the avatar 416 in the three-dimensional environment 450B (e.g., redisplays the visual representation of the first user 402 as a three-dimensional avatar). Additionally, in some examples, as shown in FIG. 4E, the first electronic device 101a updates the height of the avatar 414 corresponding to the second user 404 to be relative to the surface of the desk 406 rather than relative to the surface of the floor or ground. For example, as illustrated in the side view 410 in FIG. 4E, the avatar 414 has an updated height corresponding to the height 429 in the side view 410 (e.g., which corresponds to the height of the second user 404 relative to the virtual surface 428). Similarly, in some examples, as shown in the side view 412 in FIG. 4E, the avatar 416 corresponding to the first user 402 has an updated height that corresponds to the height 427 of the first user 402 relative to the surface of the desk 406 in the side view 410. In this way, as illustrated in FIG. 4E, the avatar 414 corresponding to the second user 404 is displayed at eye level with the first user 402 at the first electronic device 101a and the avatar 416 corresponding to the first user 402 is displayed at eye level with the second user 404 at the second electronic device 101b, enabling easier and more lifelike interaction with the content of the virtual object 407, as one benefit.

In some examples, when the heights of the avatars 414/416 are updated in their respective three-dimensional environments 450A/450B, the first electronic device 101a and the second electronic device 101b display a visual indication that indicates the heights of the avatars 414/416 have been updated. For example, the first electronic device 101a and the second electronic device 101b display a notification, a message, an icon, or other virtual element that visually indicates the heights of the avatars 414/416 have been updated, optionally specifically indicating that the heights are now relative to a surface (e.g., the surface of the desk 406 and/or the virtual surface 428) that is different from the surface of the floor or ground.

In some examples, in addition to the heights of the avatars 414/416 being updated in their respective three-dimensional environments 450A/450B, positions of the avatars 414/416 are optionally updated based on the input associating the virtual object 407 with the surface of the desk 406 in the three-dimensional environment 450A. For example, as described above, the association of the virtual object 407 with the surface of the desk 406 is caused by movement of the virtual object 407 within the three-dimensional environment 450A. In some examples, as defined herein, movement of the virtual object 407, which is a shared object in the multi-user communication session, triggers spatial refinement. Particularly, in some examples, as shown from FIG. 4C to FIG. 4E, the first electronic device 101a moves the avatar 414 with the virtual object 407 in the three-dimensional environment 450A relative to the viewpoint of the first electronic device 101a. For example, the first electronic device 101a concurrently moves the avatar 414 and the virtual object 407 toward the viewpoint of the first electronic device 101a in the three-dimensional environment 450A in accordance with the movement of the hand 403 in FIG. 4C. Similarly, in some examples, to maintain spatial truth within the spatial group of the first user 402 and the second user 404, as defined herein, the second electronic device 101b moves the avatar 416 corresponding to the first user 402 in the three-dimensional environment 450B based on the movement input detected at the first electronic device 101a. Particularly, because the movement input detected at the first electronic device 101a causes a decrease in distance between the viewpoint of the first electronic device 101a and the shared virtual objects (e.g., the avatar 414 and the virtual object 407) in the three-dimensional environment 450A, the second electronic device 101b decreases the distance (e.g., by a same or similar amount or degree) between the viewpoint of the second electronic device 101b and the avatar 416 (e.g., by moving the avatar 416 toward the viewpoint of the second electronic device 101b) in the three-dimensional environment 450B, as shown in FIG. 4E.

FIG. 4F illustrates an example of automatically associating the virtual object 407 with the surface of the desk 406 in the three-dimensional environment 450A when sharing the virtual object 407 in the multi-user communication session. For example, in FIG. 4F, while the virtual object 407 is a private object in the multi-user communication session (e.g., private to the first user 402 in the three-dimensional environment 450A as previously described herein), as indicated by the pill 417, the first electronic device 101a detects an input corresponding to a request to share the content of the virtual object 407 with the second user 404 in the three-dimensional environment 450B. In some examples, as shown in FIG. 4F, the input detected by the first electronic device 101a includes an air pinch gesture performed by hand 403 that is directed to the pill 417 in the three-dimensional environment 450A (e.g., while the gaze 426 is directed to the pill 417), as similarly described above. In some examples, when the input provided by the hand 403 is detected by the first electronic device 101a, the second electronic device 101b is displaying virtual object 432 in the three-dimensional environment 450B. In some examples, as shown in FIG. 4F, the virtual object 432 is or includes content (e.g., a user interface) that is associated with a mail application running on the second electronic device 101b. In some examples, as shown in FIG. 4F, the virtual object 432 includes and/or is displayed with grabber or handlebar 433 that is selectable to initiate movement of the virtual object 432 in the three-dimensional environment 450B relative to the viewpoint of the second electronic device 101b. Additionally, in the example of FIG. 4F, as indicated by pill 431, the content of the virtual object 432 is private to the second user 404 at the second electronic device 101b (e.g., the virtual object 432 corresponds to a private object). In the example of FIG. 4F, when the input discussed above is detected by the first electronic device 101a, the physical environment in which the second electronic device 101b is located includes table 430. Accordingly, in some examples, the three-dimensional environment 450B includes a representation of the table 430, as shown in FIG. 4F. In some examples, as previously described above, while the virtual object 407 is private to the first user 402 in the multi-user communication session, the avatars 414/416 are displayed at heights in their respective three-dimensional environments 450A/450B that are based on the heights of their corresponding users relative to the floor or ground of the three-dimensional environments 450A/450B, as illustrated in the side views 410/412 in FIG. 4F.

In some examples, as shown in FIG. 4G, in response to detecting the input performed by the hand 403, the first electronic device 101a shares the content of the virtual object 407 with the second user 404 at the second electronic device 101b. For example, as similarly discussed herein, the second electronic device 101b displays the virtual object 407 in the three-dimensional environment 450B. Additionally, in some examples, the first electronic device 101a updates display of the pill 417 in the three-dimensional environment 450A to indicate that the virtual object 407 corresponds to a shared object in the multi-user communication session.

Additionally, in some examples, when the virtual object 407 is shared in the multi-user communication session, the first electronic device 101a automatically associates the virtual object 407 with the surface of the desk 406 in the three-dimensional environment 450A. For example, the virtual object 407 is displayed on and/or anchored to the surface of the desk 406 in the three-dimensional environment 450A without requiring input from the first user 402 for associating the virtual object 407 with the surface of the desk 406 (e.g., the movement input described above with reference to FIG. 4C). In some examples, the virtual object 407 is automatically associated with the surface of the desk 406 because the virtual object 407 is an object of the first type described above (e.g., a horizontally-oriented virtual object). In some examples, the virtual object 407 is automatically associated with the surface of the desk 406 in the three-dimensional environment 450A because the virtual object 407 is located above and/or near (e.g., within a threshold distance of, such as 0.1, 0.2, 0.5, 0.75, 1, 1.5, 2, 3, etc. meters of) the surface of the desk 406 when the virtual object 407 is shared in the multi-user communication session.

In some examples, as shown in FIG. 4G, when the virtual object 407 is shared with the second electronic device 101b, the second electronic device 101b displays (e.g., anchors) the virtual object 407 on the surface of the table 430 in the three-dimensional environment 450B (e.g., rather than on a virtual surface, such as the virtual surface 428 discussed above). In some examples, the second electronic device 101b displays the virtual object 407 on the surface of the table 430 in the three-dimensional environment 450B because one or more characteristics of the table 430 is similar to one or more characteristics of the desk 406. For example, the desk 406 and the table 430 have similar shapes and/or sizes, similar surface area, occupy similar amounts of the field of view of the electronic devices 101a/101b, and/or have similar heights relative to the viewpoints of the electronic devices 101a/101b. In some examples, as illustrated in the side views 410/412 in FIG. 4G, the height of the table 430 relative to the floor or ground of the physical environment of the second electronic device 101b is greater than the height of the desk 406 relative to the floor or ground of the physical environment of the first electronic device 101a.

In some examples, as similarly discussed above, when the virtual object 407 is shared in the multi-user communication session and associated with the surfaces in the three-dimensional environments 450A/450B that are different from the surfaces of the floors in the three-dimensional environments 450A/450B (e.g., the surfaces of the desk 406 and table 430), the electronic devices 101a/101b update display of the avatars 414/416. For example, as shown in FIG. 4G, the first electronic device 101a updates display of the height of the avatar 414 in the three-dimensional environment 450A and the second electronic device 101b updates display of the height of the avatar 416 in the three-dimensional environment 450B. Particularly, in some examples, the first electronic device 101a updates the height of the avatar 414 to correspond to a height of the second user 404 that is relative to the surface of the table 430 and the second electronic device 101b updates the height of the avatar 416 to correspond to a height of the first user 402 that is relative to the surface of the desk 406. For example, as illustrated in the side view 410, the first electronic device 101a determines height 427 of the first user 402 that is relative to the surface of the desk 406 in the three-dimensional environment 450A, and transmits data corresponding to the determined height 427 to the second electronic device 101b. Similarly, as illustrated in the side view 412, the second electronic device 101b determines height 439 of the second user 404 that is relative to the surface of the table 430 in the three-dimensional environment 450B, and transmits data corresponding to the determined height 439 to the first electronic device 101a. Then, as similarly described herein, in some examples, the first electronic device 101a positions the avatar 414 at height 437 relative to the surface of the desk 406 in the three-dimensional environment 450A, as illustrated in the side view 410 in FIG. 4G, where the height 437 corresponds to (e.g., is equal to) the height 439 of the second user 404 relative to the surface of the table 430 in the side view 412. Additionally, in some examples, the second electronic device 101b positions the avatar 416 at height 429 relative to the surface of the table 430 in the three-dimensional environment 450B, as illustrated in the side view 412 in FIG. 4G, where the height 429 corresponds to (e.g., is equal to) the height 427 of the first user 402 relative to the surface of the desk 406 in the side view 410. Accordingly, though the users and the avatars are not perfectly aligned at eye level when the virtual object 407 is shared in the multi-user communication session, the avatars remain sufficiently viewable to the users in their respective three-dimensional environments while simulating near real heights of the users in their respective physical environments, thereby enabling easier and more lifelike interaction with the content of the virtual object 407, as one benefit.

In FIG. 4H, the second electronic device 101b detects an input corresponding to a request to share the virtual object 432 (e.g., in place of and/or instead of the virtual object) in the multi-user communication session. For example, as shown in FIG. 4H, the second electronic device 101b detects an air pinch gesture performed by hand 405 of the second user 404, optionally while gaze 426 of the second user 404 is directed to the pill 431 of the virtual object 432. In some examples, as shown in FIG. 4H, the second electronic device 101b detects the input provided by the hand 405 while the virtual object 407 is shared in the multi-user communication session.

In some examples, as shown in FIG. 4I, in response to detecting the input provided by the hand 405, the second electronic device 101b shares the virtual object 432 with the first user 402 at the first electronic device 101a. For example, as shown in FIG. 4I, the first electronic device 101a displays the virtual object 432 in the three-dimensional environment 450A with the pill 431 being updated to indicate that the virtual object 432 is a shared object in the multi-user communication session. In some examples, as similarly discussed above, when the virtual object 432 is shared with the first user 402 at the first electronic device 101a, the content (e.g., the mail user interface) of the virtual object 432 becomes visible to and/or interactive to the first user 402 in the three-dimensional environment 450A, as shown in FIG. 4I. In some examples, the first electronic device 101a and the second electronic device 101b limit a number of applications (e.g., content) that are able to be shared in the multi-user communication session. For example, in FIG. 4I, a single application (e.g., optionally a single virtual object) is able to be shared in the multi-user communication session at a time. Accordingly, in some examples, as shown in FIG. 4I, when the virtual object 432 becomes shared in the multi-user communication session, the virtual object 407 is returned to (e.g., reverts to) being a private object in the multi-user communication session. For example, as shown in FIG. 4I, the virtual object 407 is no longer displayed in the three-dimensional environment 450B (e.g., because the virtual object 407 is no longer shared with the second electronic device 101b) and the pill 417 of the virtual object 407 in the three-dimensional environment 450A is updated to reflect that the virtual object 407 is once again private to the first user 402 at the first electronic device 101a.

In some examples, when the second electronic device 101b shares the content of the virtual object 432 with the first electronic device 101a, the display of the avatars 414/416 is updated in their respective three-dimensional environments. Particularly, in some examples, the first electronic device 101a updates the height of the avatar 414 in the three-dimensional environment 450A and the second electronic device 101b updates the height of the avatar 416 in the three-dimensional environment 450B. In some examples, as indicated in the side views 410/412 in FIG. 4I, the heights of the avatars 414/416 are updated to no longer be relative to the surfaces of the desk 406 and the table 430, but to the floor of the physical environments of electronic devices 101a/101b. For example, as shown in FIG. 4I, the first electronic device 101a updates the height 437 of the avatar 414 to correspond to (e.g., to be the same as) the height of the second user 404 relative to the floor of the physical environment of the second electronic device 101b, as shown in the side view 410. Similarly, in some examples, as shown in the side view 412 in FIG. 4I, the second electronic device 101b updates the height 429 of the avatar 416 to correspond to the height of the first user 402 relative to the floor of the physical environment of the first electronic device 101a. In some examples, the heights of the avatars 414/416 are updated when the virtual object 432 is shared in the multi-user communication session because the virtual object 432 corresponds to an object of a second type, different from the object of the first type discussed above. For example, in FIG. 4I, the virtual object 432 is or includes content that has a vertical orientation in the three-dimensional environments 450A/450B (e.g., an object of the second type corresponds to a vertically oriented virtual object). As described previously above, in some examples, the electronic devices 101a/101b update display of the heights of the avatars 414/416 for horizontally oriented objects to enable the avatars 414/416 to be displayed at or near eye level with the users of the electronic devices 101a/101b, which enriches mutual and/or cooperative interaction with the horizontally oriented objects. However, such may not be the case for vertically oriented objects (e.g., maintaining eye level between users and avatars may not necessarily enrich and/or facilitate interaction with content in a vertically oriented object). Accordingly, to help preserve computing resources and device power, the avatars 414/416 are returned to being displayed at heights that are relative to the floor or ground of the physical environments in which the electronic devices 101a/101b are located (e.g., according to the default manner of display of the avatars).

It should be understood that the above-described manner of updating a height at which the avatars 414/416 are displayed in the three-dimensional environments 450A/450B similarly applies to multi-user communication sessions that include more than two users. For example, if the multi-user communication session above includes a third user of a third electronic device (not shown), the display of an avatar corresponding to the third user is updated in a same or similar manner as the display of the avatars 414/416 (e.g., to be relative to a physical surface or a virtual surface that is different from the floor or ground of the three-dimensional environments 450A/450B) when sharing and/or interacting with virtual objects that are horizontally oriented (e.g., the virtual object 407 above). Attention is now directed toward examples of facilitating spatial refinement of virtual objects (e.g., avatars and/or virtual content) within a multi-user communication session.

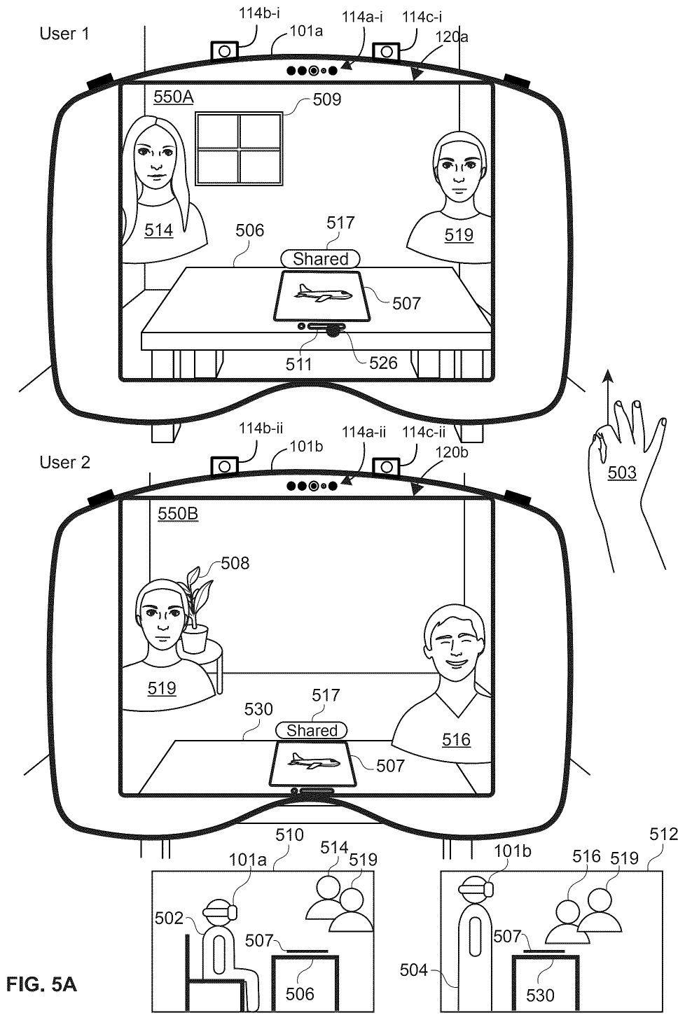

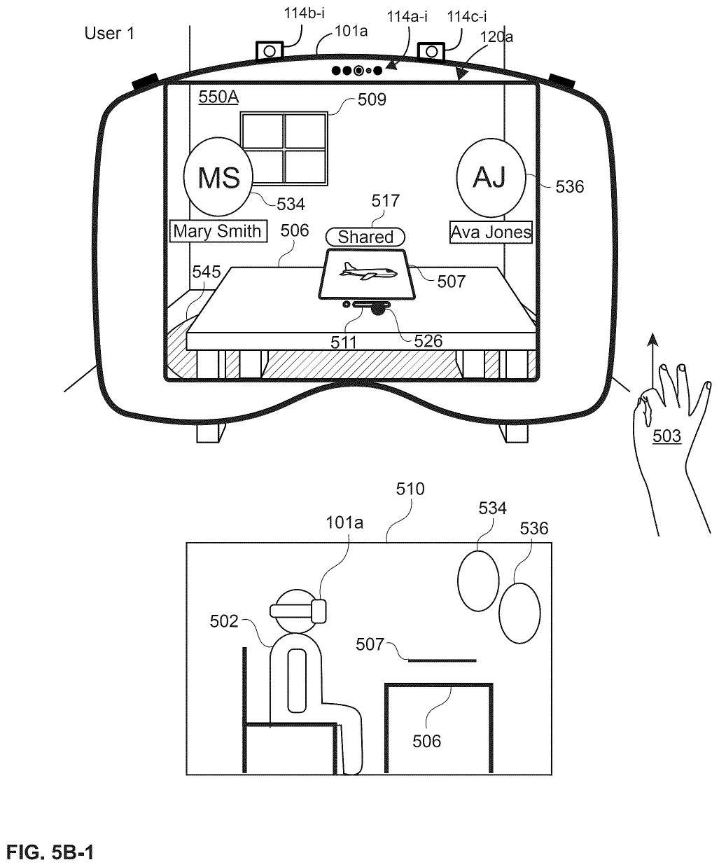

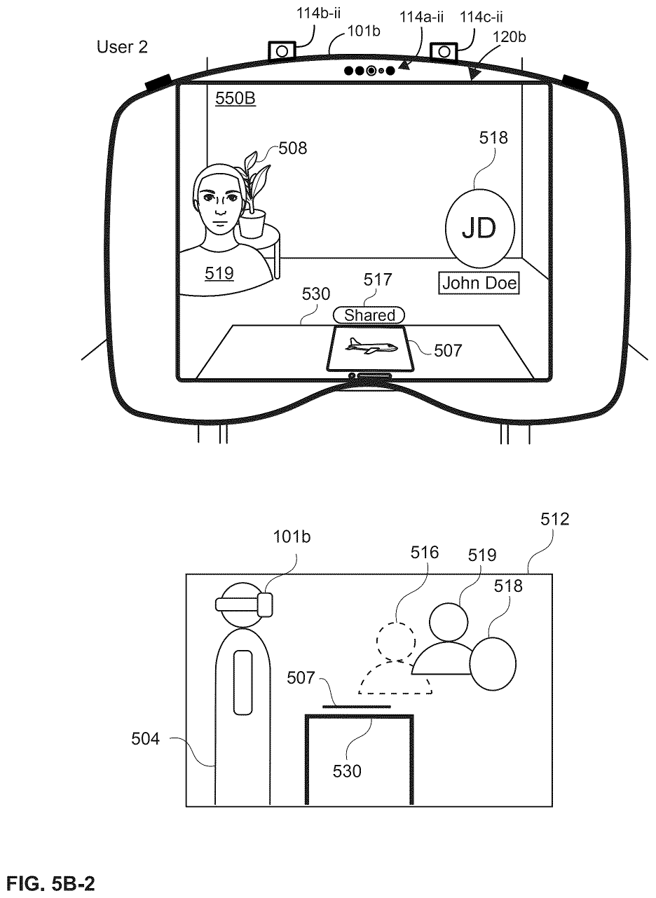

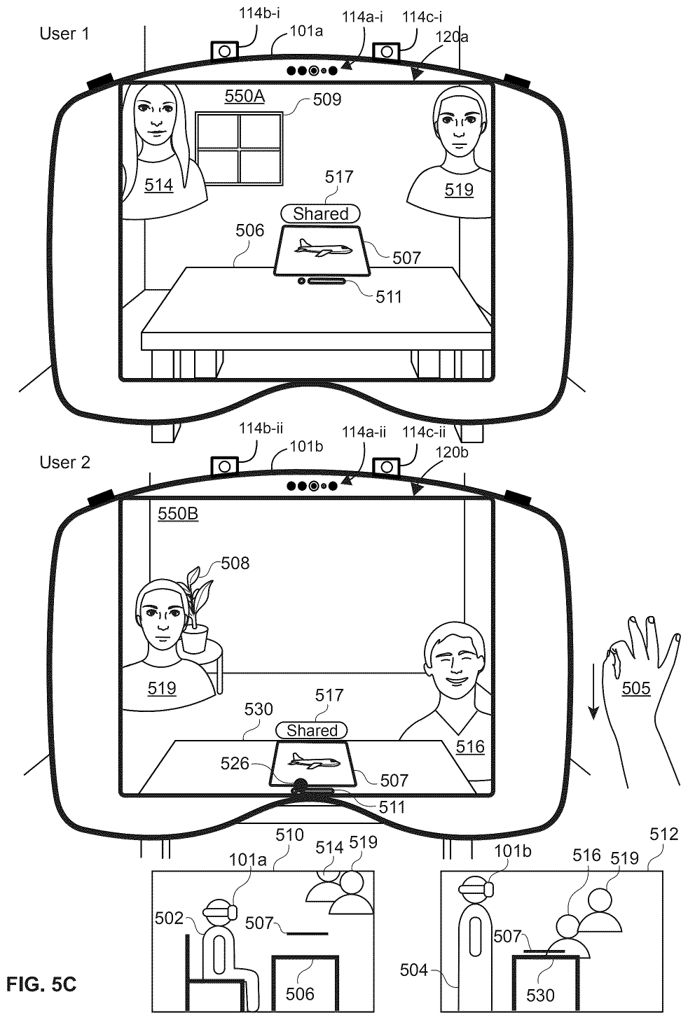

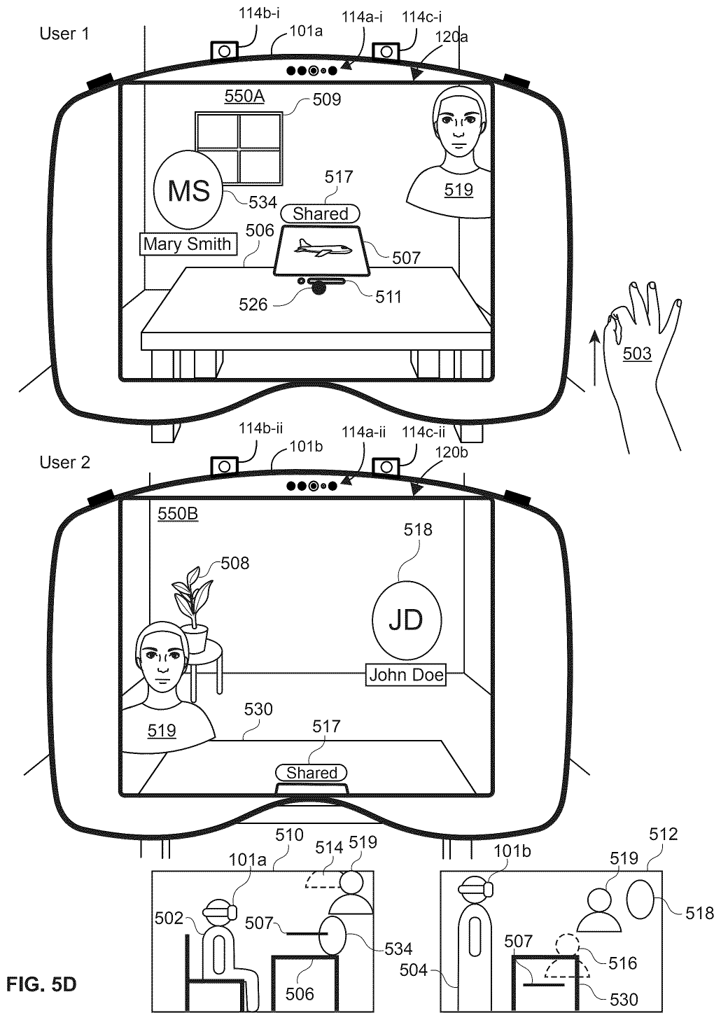

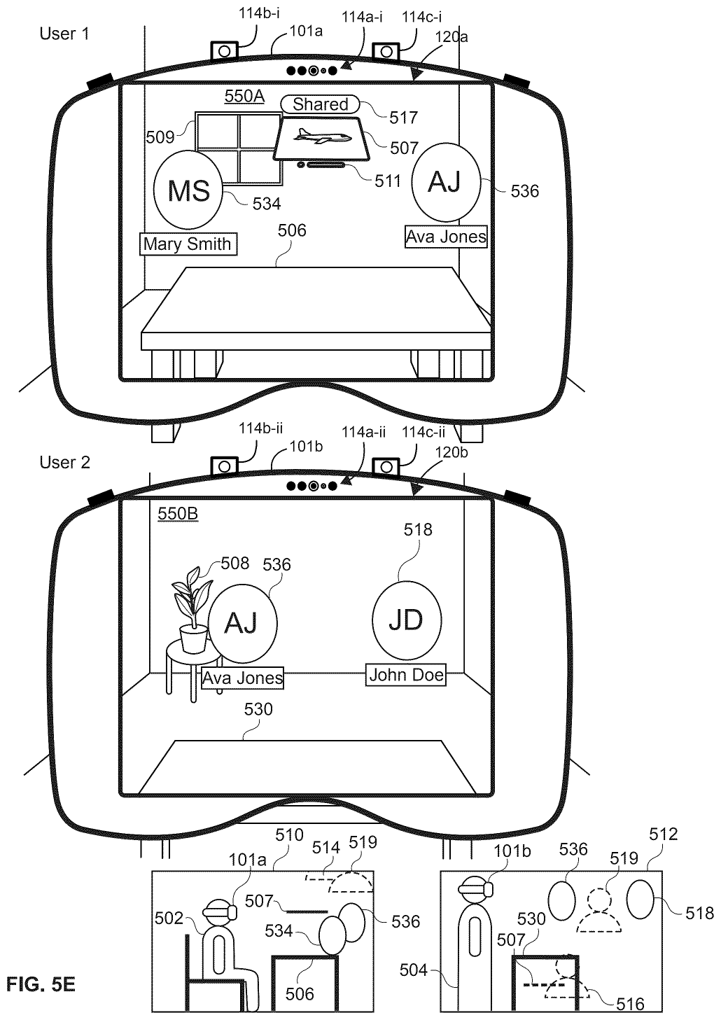

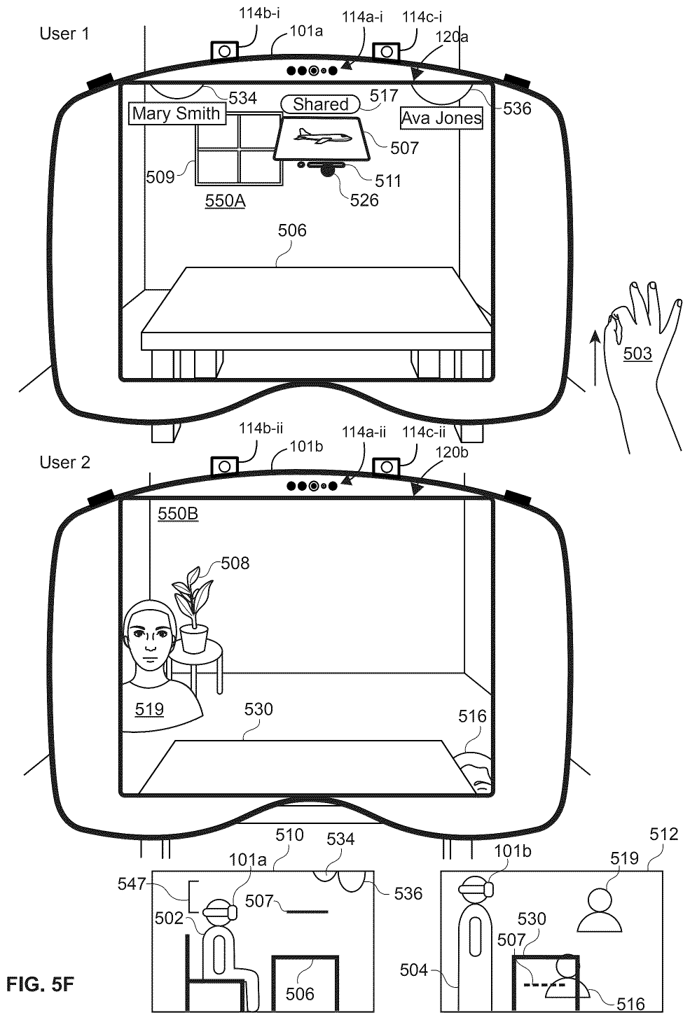

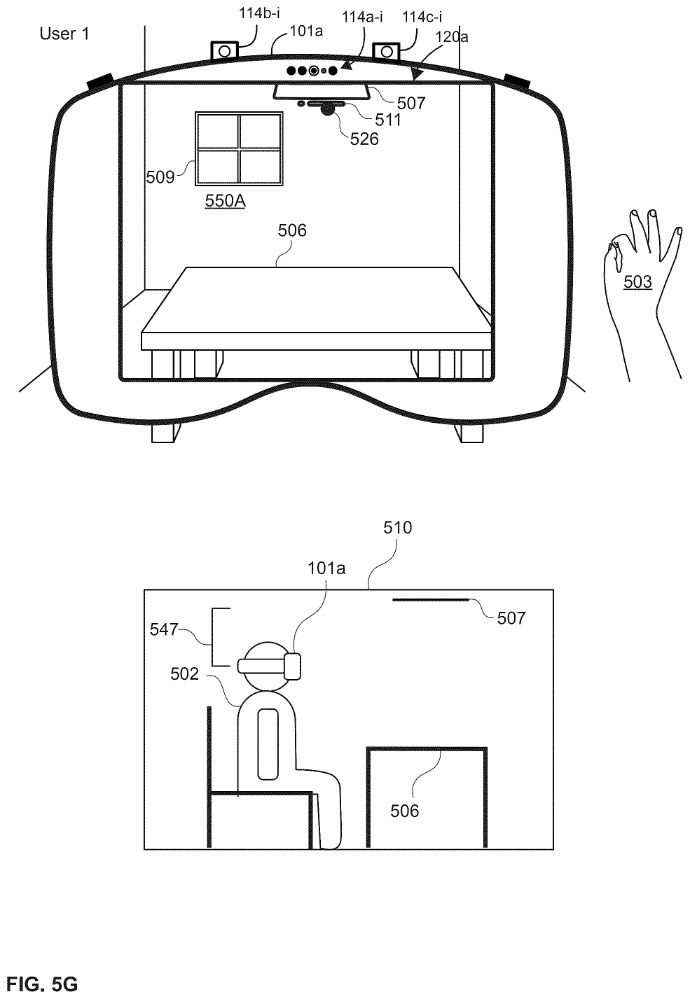

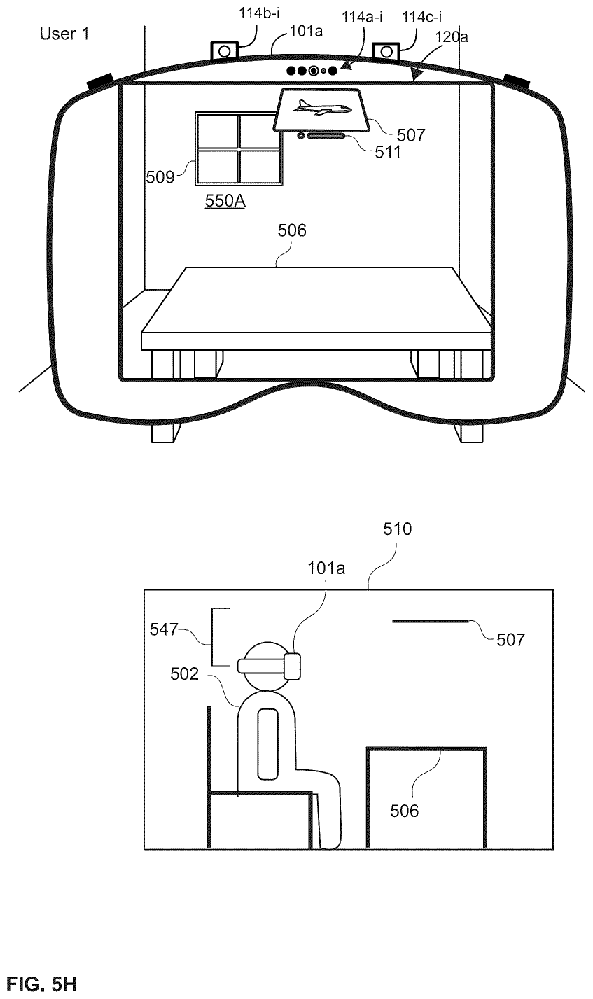

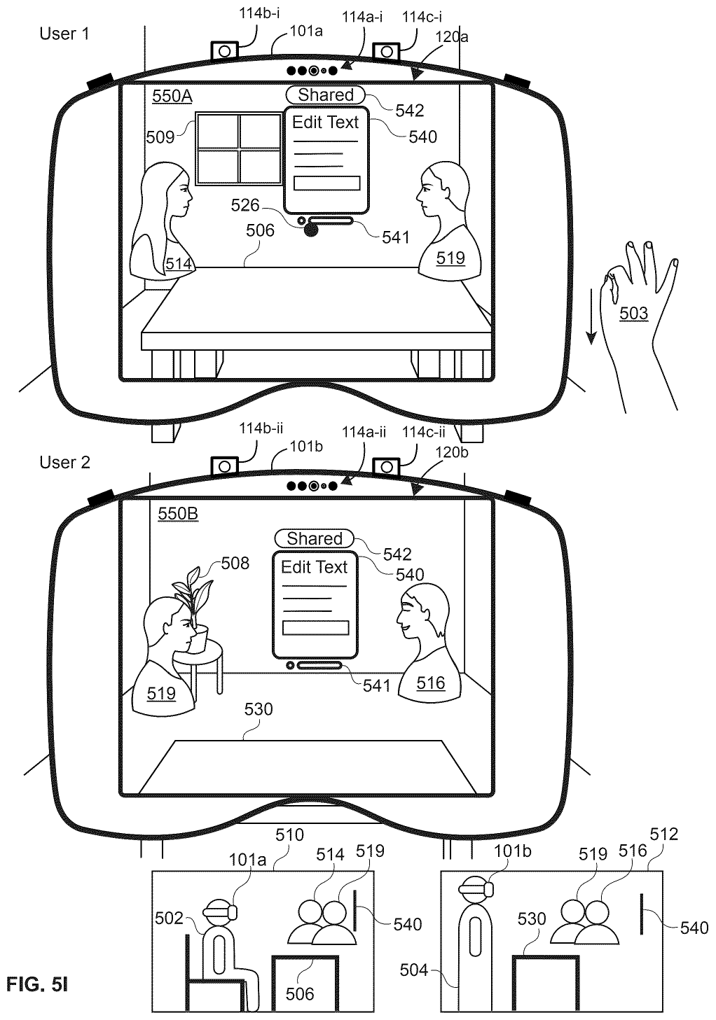

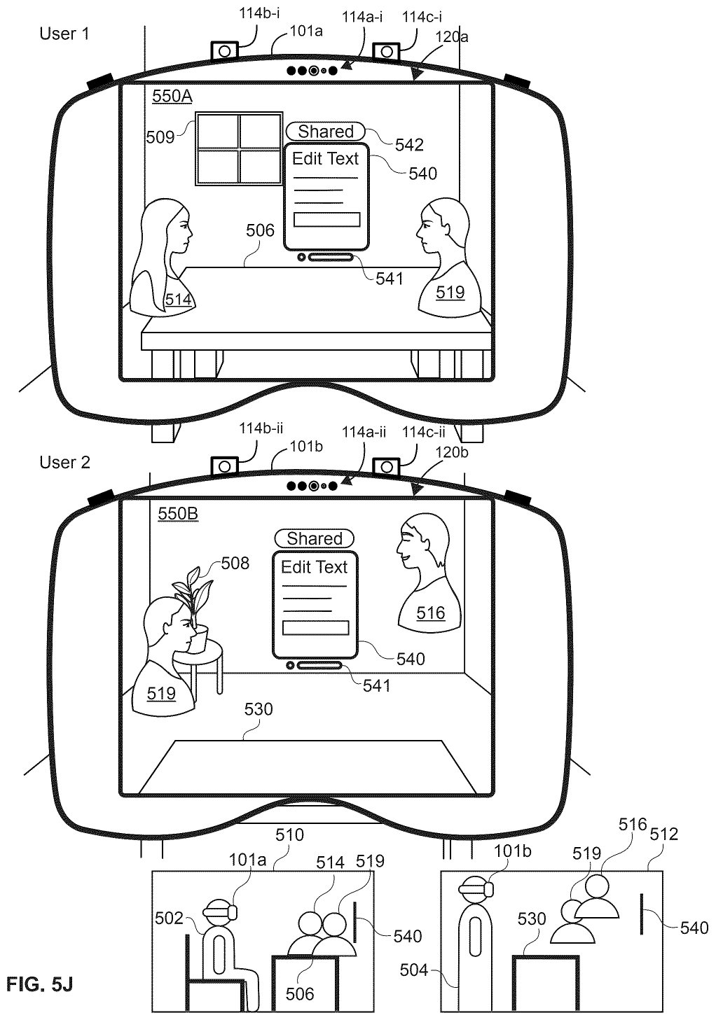

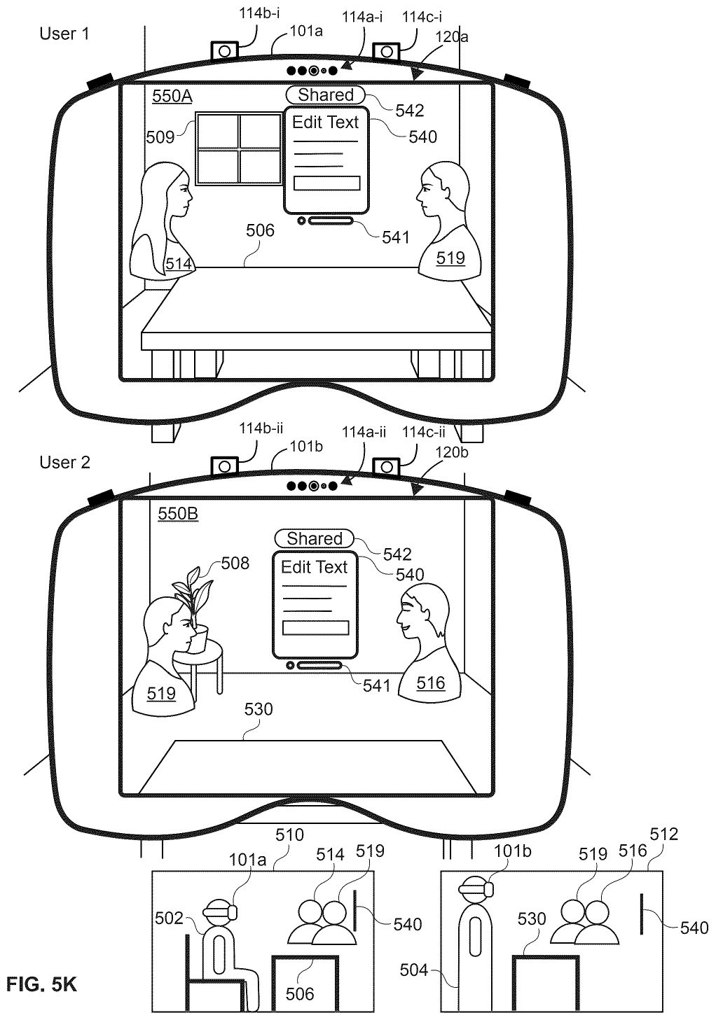

FIGS. 5A-5K illustrate examples of moving shared content vertically in a three-dimensional relative to surfaces in the three-dimensional environment within a multi-user communication session according to some examples of the disclosure. In FIG. 5A, first electronic device 101a (e.g., associated with first user 502), second electronic device 101b (e.g., associated with second user 504), and third electronic device 101c (e.g., associated with a third user) are in a multi-user communication session, as similarly discussed above. In some examples, the first user 502 and the second user 504 correspond to first user 402 and second user 404, respectively, of FIGS. 4A-4I.

As shown in FIG. 5A, the first electronic device 101a is presenting (e.g., via display 120a) three-dimensional environment 550A. In FIG. 5A, as similarly discussed above, the three-dimensional environment 550A includes representations (e.g., passthrough representations or computer-generated representations) of the physical environment of the first electronic device 101a. For example, as shown in FIG. 5A, the physical environment corresponds to a room that includes desk 506 and window 509. Accordingly, as shown in FIG. 5A, the three-dimensional environment 550A presented using the first electronic device 101a includes representations of the desk 506 and the window 509 (e.g., the desk 506 and the window 509 are visible in a field of view of the first electronic device 101a). Similarly, as shown in FIG. 5A, the second electronic device 101b is presenting (e.g., via display 120b) three-dimensional environment 550B. In FIG. 5A, as similarly discussed above, the three-dimensional environment 550B includes representations (e.g., passthrough representations or computer-generated representations) of the physical environment of the first electronic device 101a. For example, as shown in FIG. 5A, the physical environment corresponds to a room that includes table 530 and houseplant 508. Accordingly, as shown in FIG. 5A, the three-dimensional environment 550B presented using the second electronic device 101b includes representations of the table 530 and the houseplant 508 (e.g., the table 530 and the houseplant 508 are visible in a field of view of the second electronic device 101b). In some examples, the three-dimensional environments 550A/550B have one or more characteristics of three-dimensional environments 450A/450B discussed above.

Additionally, in FIG. 5A, the three-dimensional environments presented by the electronic devices in the multi-user communication session include visual representations (e.g., avatars) corresponding to the users of the electronic devices. For example, as similarly discussed above, in FIG. 5A, the three-dimensional environment 550A presented at the first electronic device 101a includes avatar 514 corresponding to the second user 504 and avatar 519 corresponding to the third user of the third electronic device (not shown). Similarly, as shown in FIG. 5A, in some examples, the three-dimensional environment 550B presented at the second electronic device 101b includes avatar 516 corresponding to the first user 502 and the avatar 519 corresponding to the third user. In some examples, the avatars 514/516 correspond to avatars 414/416 described above. Additionally, in some examples, as shown in FIG. 5A, the three-dimensional environments 550A/550B include virtual object 507. In some examples, the virtual object 507 is associated with a respective application running on the electronic devices 101a/101b, such as an image editing or image viewing application, a video game or board game application, etc. In some examples, the virtual object 507 includes or is displayed with grabber or handlebar 511 that is selectable to initiate movement of the virtual object 507 in the three-dimensional environment 550A/550B. Additionally, in some examples, the virtual object 507 corresponds to a shared object within the multi-user communication session. For example, as indicated by pill 517 displayed with the virtual object 507 in FIG. 5A, the content of the virtual object 507 (e.g., the image of the airplane) is viewable by and/or interactive to the first user 502, the second user 504, and the third user in the multi-user communication session (e.g., via their respective electronic devices). In some examples, the virtual object 507 corresponds to virtual object 407 discussed above.

In some examples, as similarly discussed above, while the first electronic device 101a, the second electronic device 101b, and the third electronic device are communicatively linked in the multi-user communication session, the first user 502, the second user 504, and the third user are associated with a same spatial group in the multi-user communication session according to which spatial truth is defined for the first user 502, the second user 504, and the third user. In some examples, maintaining spatial truth within the spatial group includes triggering spatial refinement in accordance with a determination that a movement input is detected as being directed to a shared object within the multi-user communication session. In some examples, the electronic devices in the multi-user communication session facilitate vertical spatial refinement, as discussed below, in response to detecting a movement input corresponding to vertical movement of a shared object within the multi-user communication session.

In FIG. 5A, the first electronic device 101a detects an input provided by hand 503 of the first user 502 corresponding to a request to move the virtual object 507 in the three-dimensional environment 550A. For example, as shown in FIG. 5A, the first electronic device 101a detects an air pinch and drag gesture performed by the hand 503, optionally while gaze 526 of the first user 502 is directed to the grabber 511 associated with the virtual object 507 in the three-dimensional environment 550A. In some examples, the movement of the virtual object 507 corresponds to vertical (e.g., upward) movement of the virtual object 507 relative to the viewpoint of the first electronic device 101a, as indicated in FIG. 5A.

In some examples, as mentioned above, in response to detecting the input provided by the hand 503 of the first user 502 corresponding to the request to move the virtual object 507 in the three-dimensional environment 550A, the first electronic device 101a initiates spatial refinement within the multi-user communication session. Particularly, in some examples, as shown from FIG. 5A to FIG. 5B-1, the first electronic device 101a moves the (e.g., shared) virtual objects within the three-dimensional environment 550A vertically relative to the viewpoint of the first electronic device 101a, notably the virtual object 507 and the visual representations of the users of the second electronic device 101b and the third electronic device 101c, in accordance with the upward movement of the hand 503. In some examples, as shown in FIG. 5B-1, when and/or while spatial refinement is triggered in the multi-user communication session (e.g., while the first user 502 continues to provide the air pinch and drag gesture illustrated in FIG. 5B-1), the first electronic device 101a replaces display of the avatars 514/519 in the three-dimensional environment 550A with spatial coins 534/536. For example, as shown in FIG. 5B-1, the first electronic device 101a replaces display of the avatar 514 corresponding to the second user 504 with a two-dimensional representation of the second user 504 (e.g., the spatial coin 534) and replaces display of the avatar 536 corresponding to the third user with a two-dimensional representation of the third user (e.g., the spatial coin 536), as illustrated in the side view 510. In some examples, as shown in FIG. 5B-1, the spatial coin 534 includes an indication of a name of the second user 504 (e.g., Mary Smith) and a two-dimensional visual representation (e.g., image, photograph, icon, cartoon, sketch, etc.) of the second user 504. Similarly, in some examples, the spatial coin 536 includes an indication of a name of the third user (e.g., Ava Jones) and a two-dimensional visual representation of the third user, as shown in FIG. 5B-1. In some examples, the spatial coins 534/536 provide a visual indication to the first user 502 that the interaction with the virtual object 507 has triggered spatial refinement in the multi-user communication session (e.g., and will thus result in the repositioning of the virtual object 507 and the visual representations of the users of the second electronic device 101b and the third electronic device as described below).

Additionally, in some examples, as shown in FIG. 5B-1, when and/or while spatial refinement is triggered in the multi-user communication session, the first electronic device 101a displays virtual element 545 (e.g., a virtual ring, circle, platter, disc, or other virtual indication) in the three-dimensional environment 550A. In some examples, as illustrated in FIG. 5B-1, the virtual element 545 is displayed below the virtual objects that are being moved according to the principles of spatial refinement, notably the virtual object 507 and the spatial coins 534/536 discussed above, in the three-dimensional environment 550A from the viewpoint of the first electronic device 101a. In some examples, a location at which the virtual element 545 is displayed in the three-dimensional environment 550A is based on one or more boundaries of the three-dimensional environment 550A, which correspond to one or more boundaries for the vertical movement of the virtual object 507 (e.g., while spatial refinement is active). For example, in FIG. 5B-1, the first electronic device 101a displays the virtual element 545 on a floor or ground of the physical environment that is visible in the three-dimensional environment 550A from the viewpoint of the first electronic device 101a, visually indicating to the first user 502 that the floor or ground of the physical environment corresponds to a boundary for the vertical movement of the virtual object 507 in the three-dimensional environment 550A. In some examples, the virtual element 545 remains displayed in the three-dimensional environment 550A while spatial refinement is active in the multi-user communication session (e.g., for the duration that the first user 502 interacts with the virtual object 507 in the three-dimensional environment 550A). Additionally, in some examples, the virtual element 545 does not move (e.g., is not translated laterally and/or is not raised or lowered vertically) in the three-dimensional environment 550A while spatial refinement is active in the multi-user communication session and while the virtual object 507 is being moved vertically in the three-dimensional environment 550A relative to the viewpoint of the first electronic device 101a.

It is understood that, in some examples, the first electronic device 101a displays the virtual element 545 in the three-dimensional environment 550A for additional and/or alternative types of movement that trigger spatial refinement, such as horizontal movement of the virtual object 507 in the three-dimensional environment 550A within the multi-user communication session. It is also understood that, in some examples, the first electronic device 101a displays the virtual element 545 at additional and/or alternative locations in the three-dimensional environment 550A that correspond to boundaries for the vertical movement of the virtual object 507 in the three-dimensional environment 550A, such as on a ceiling of the physical environment that is visible in the three-dimensional environment 550A from the viewpoint of the first electronic device 101a.

In some examples, as shown in FIG. 5B-2, as similarly discussed above, while the first electronic device 101a is detecting the air pinch and drag gesture directed to the virtual object 507 provided by the hand 503 of the first user 502, the second electronic device 101b updates display of the avatar 516 corresponding to the first user 502 in the three-dimensional environment 550B. For example, as shown in FIG. 5B-2, the second electronic device 101b replaces the avatar 516, as indicated in side view 512, with a two-dimensional representation of the first user 502, such as spatial coin 518, in the three-dimensional environment 550B. In some examples, as shown in FIG. 5B-2, the spatial coin 518 includes an indication of a name of the first user 502 (e.g., John Doe) and a two-dimensional visual representation (e.g., image, photograph, icon, cartoon, sketch, etc.) of the first user 502. In some examples, the spatial coin 518 provides a visual indication to the second user 504 that the first user 502 is interacting with the virtual object 507 (e.g., is moving the virtual object 507 as described above). In some examples, the first electronic device 101a transmits an indication of the input provided by the first user 502 to the second electronic device 101b when the input is detected by the first electronic device 101a, which enables and/or causes the second electronic device 101b to update display of the visual representation of the first user 502 in the three-dimensional environment 550B (e.g., from the three-dimensional avatar to the two-dimensional spatial coin). In some examples, the spatial coin 518 has one or more characteristics of spatial coin 418 described above. Additionally, in some examples, as shown in FIG. 5B-2, because the movement input directed to the virtual object 507 is being provided by the first user 502 at the first electronic device 101a, the second electronic device 101b maintains display of the visual representation of the third user in the three-dimensional environment 550B as the three-dimensional avatar 519 (e.g., and thus forgoes replacing the avatar 519 with a spatial coin corresponding to the third user). Further, in some examples, as shown in FIG. 5B-2, because the movement input directed to the virtual object 507 is being provided by the first user 502 of the first electronic device 101a, the second electronic device 101b forgoes displaying the virtual element 545 discussed above in the three-dimensional environment 550B.

In some examples, as shown in FIG. 5C, in response to detecting the input provided by the hand 503, the first electronic device 101a moves the virtual object 507 vertically in the three-dimensional environment 550A relative to the viewpoint of the first electronic device 101a in accordance with the movement of the hand 503. For example, as shown in FIG. 5C, the first electronic device 101a moves the virtual object 507 upward in the three-dimensional environment 550A relative to the viewpoint of the first electronic device 101a in accordance with the upward movement of the hand 503. Additionally, in some examples, in response to and/or after detecting a conclusion (e.g., termination) of the input provided by the hand 503 (e.g., a release of the air pinch gesture provided by the hand 503) detected by the first electronic device 101a, the second electronic device 101b redisplays the avatar 516 in the three-dimensional environment 550B (e.g., redisplays the visual representation of the first user 502 as a three-dimensional avatar).

Additionally, as defined herein, the above movement of the virtual object 507, which is a shared object in the multi-user communication session, optionally triggers spatial refinement. Particularly, in some examples, as shown from FIG. 5A to FIG. 5C, the first electronic device 101a moves the avatars 514/519 with the virtual object 507 in the three-dimensional environment 550A relative to the viewpoint of the first electronic device 101a. For example, the first electronic device 101a concurrently moves the avatars 514/519 and the virtual object 507 vertically upward in the three-dimensional environment 550A relative to the viewpoint of the first electronic device 101a in accordance with the movement of the hand 503 in FIG. 5A. Similarly, in some examples, to maintain spatial truth within the spatial group of the first user 502, the second user 504, and the third user, as defined herein, the second electronic device 101b (e.g., and the third electronic device) moves the avatar 516 corresponding to the first user 502 in the three-dimensional environment 550B based on the movement input detected at the first electronic device 101a (e.g., without moving the avatar 519 and the virtual object 507 in the three-dimensional environment 550B). Particularly, because the movement input detected at the first electronic device 101a causes the shared virtual objects (e.g., the avatars 514/516 and the virtual object 507) to be raised (e.g., vertically) in the three-dimensional environment 550A relative to the viewpoint of the first electronic device 101a, the second electronic device 101b (e.g., and the third electronic device) lowers the avatar 516 (e.g., by a same or similar amount or degree, such as distance) in the three-dimensional environment 550B relative the viewpoint of the second electronic device 101b (e.g., such that a spatial arrangement and distribution of the avatars 514/519 and the virtual object 507 relative to the viewpoint of the first electronic device 101a in the three-dimensional environment 550A corresponds to (e.g., is the same as) a spatial arrangement and distribution of the avatar 519, the viewpoint of the second electronic device 101b, and the virtual object 507 relative to the avatar 516 in the three-dimensional environment 550B), as shown in FIG. 5C.

In some examples, the first electronic device 101a spatially refines the avatars 514/519 and the virtual object 507 in the three-dimensional environment 550A in accordance with the movement of the hand 503 by moving the avatars 514/519 and the virtual object 507 relative to a respective surface in the three-dimensional environment 550A. For example, in FIG. 5C, the first electronic device 101a increases a height of each of the avatars 514/519 and the virtual object 507 in the three-dimensional environment 550A, which is based on the movement of the hand 503, relative to the surface of the desk 506 in the three-dimensional environment 550A. Particularly, in some examples, the first electronic device 101a correlates a magnitude (e.g., of distance) of the movement of the hand 503 in space relative to the viewpoint of the first electronic device 101a with a magnitude (e.g., of distance) of vertical movement of the avatars 514/519 and the virtual object 507 relative to the surface of the desk 506. In some examples, the vertical movement of the avatars 514/519 and the virtual object 507 is selected to be relative to the surface of the desk 506 in the three-dimensional environment 550A because, when the input provided by the hand 503 above is detected by the first electronic device 101a, the virtual object 507 is positioned on (e.g., displayed on and/or anchored to) the surface of the desk 506. Additionally or alternatively, in some examples, the vertical movement of the avatars 514/519 and the virtual object 507 is selected to be relative to the surface of the desk 506 in the three-dimensional environment 550A because, when the input provided by the hand 503 above is detected by the first electronic device 101a, the virtual object 507 is or corresponds to a horizontally oriented virtual object (e.g., an object of the first type as described above).

In FIG. 5C, the second electronic device 101b detects an input provided by hand 505 of the second user 504 corresponding to a request to move the virtual object 507 in the three-dimensional environment 550B relative to the viewpoint of the second electronic device 101b. For example, as shown in FIG. 5C, the second electronic device 101b detects an air pinch and drag gesture performed by the hand 505, optionally while gaze 526 of the second user 504 is directed to the grabber 511 associated with the virtual object 507 in the three-dimensional environment 550B. In some examples, as indicated in FIG. 5C, the input directed to the virtual object 507 corresponds to a request to move the virtual object 507 vertically downward in the three-dimensional environment 550B relative to the viewpoint of the second electronic device 101b.

In some examples, as shown in FIG. 5D, in response to detecting the movement of the hand 505 of the second user 504, the second electronic device 101b moves the virtual object 507 vertically downward in the three-dimensional environment 550B relative to the viewpoint of the second electronic device 101b in accordance with the movement of the hand 505. Additionally, as previously discussed above, in some examples, because the movement input provided by the hand 505 is directed to a shared virtual object, the second electronic device 101b performs spatial refinement in accordance with the movement of the hand 505. For example, as shown in the side view 512 in FIG. 5D, the second electronic device 101b (e.g., concurrently) moves the avatars 516/519 and the virtual object 507 vertically downward in the three-dimensional environment 550B in accordance with the downward movement of the hand 505 (e.g., in accordance with a magnitude of the movement of the hand 505). Additionally, in some examples, as shown in side view 510 in FIG. 5D, to maintain spatial truth within the spatial group of the first user 502, the second user 504, and the third user, the first electronic device 101a (e.g., and the third electronic device) moves the avatar 514 corresponding to the second user 504 (e.g., vertically upward) in the three-dimensional environment 550A based on the movement input detected at the second electronic device 101b (e.g., without moving the avatar 519 and the virtual object 507 in the three-dimensional environment 550A), as similarly discussed above.

In some examples, spatial refinement of the virtual objects in the multi-user communication session is bounded by (e.g., limited by) one or more boundaries associated with the three-dimensional environments 550A/550B. In some examples, the one or more boundaries associated with the three-dimensional environments 550A/550B correspond to (e.g., are defined by) physical boundaries of the physical environments in the three-dimensional environments 550A/550B. For example, as shown in FIG. 5D, the walls, ceiling, and/or floor of the physical environments of the first electronic device 101a and the second electronic device 101b define boundaries of the three-dimensional environments 550A/550B. In some examples, the one or more boundaries associated with the three-dimensional environments 550A/550B correspond to (e.g., are defined by) physical objects and/or surfaces of the physical objects in the physical environment in the three-dimensional environments 550A/550B. For example, in FIG. 5D, the surfaces of the desk 506 and the table 530 define boundaries of the three-dimensional environments 550A/550B. In some examples, the one or more boundaries of the three-dimensional environment 550A at the first electronic device 101a may be different from the one or more boundaries of the three-dimensional environment 550B at the second electronic device 101b. For example, a boundary defined by a physical boundary of physical environment in the three-dimensional environment 550A at the first electronic device 101a, such as a physical wall or ceiling, may be smaller (e.g., closer to the viewpoint of the first electronic device 101a) than a similar boundary defined by a physical boundary of the physical environment in the three-dimensional environment 550B at the second electronic device 101b. As another example, a boundary defined by a physical surface of a physical object in the physical environment in the three-dimensional environment 550A at the first electronic device 101a, such as the surface of the desk 506, may be at a height and/or location relative to the viewpoint of the first electronic device 101a than a similar boundary defined by a physical surface of a physical object (e.g., surface of the table 530) in the physical environment in the three-dimensional environment 550B at the second electronic device 101b.

In some examples, in accordance with a determination that the vertical movement of virtual object 507 (e.g., which triggers spatial refinement as discussed above) causes a respective three-dimensional visual representation of a respective user to intersect and/or exceed a boundary of the one or more boundaries of the three-dimensional environment presented at a respective electronic device, the respective electronic device updates display of the three-dimensional visual representation to be a two-dimensional visual representation. For example, in FIG. 5D, the second electronic device 101b determines that, when the virtual object 507, the avatar 516, and the avatar 519 are vertically moved downward in the three-dimensional environment 550B relative to the viewpoint of the second electronic device 101b in accordance with the movement of the hand 505, the avatar 516 corresponding to the first user 502 crosses (e.g., exceeds) a boundary of the three-dimensional environment 550B that is defined by the physical surface of the table 530, as illustrated by the location of the avatar 516 in the side view 512. Accordingly, as shown in FIG. 5D, the second electronic device 101b optionally replaces display of the avatar 516 with the spatial coin 518 which corresponds to a two-dimensional visual representation of the first user 502 in the three-dimensional environment 550B. In some examples, as shown in FIG. 5D, because the movement of the virtual object 507, the avatar 514, and the avatar 519 in accordance with the movement of the hand 503 does not cause the avatar 519 to cross a boundary of the three-dimensional environment 550A, the first electronic device 101a maintains display of the avatar 519 in the three-dimensional environment 550A. Further, in some examples, in FIG. 5D, the first electronic device 101a determines that, when the avatar 514 is vertically moved upward in the three-dimensional environment 550A relative to the viewpoint of the first electronic device 101a in accordance with the movement input detected at the second electronic device 101b, the avatar 514 corresponding to the second user 504 crosses (e.g., exceeds) a boundary of the three-dimensional environment 550A that is defined by the ceiling of the physical environment in which the first electronic device 101a is located, as illustrated by the location of the avatar 514 in the side view 510. Accordingly, as shown in FIG. 5D, the first electronic device 101a optionally replaces display of the avatar 514 with spatial coin 534 which corresponds to a two-dimensional visual representation of the second user 504 in the three-dimensional environment 550A. In some examples, the spatial coin 534 has one or more characteristics of the spatial coin 518 discussed above.

In some examples, as illustrated in FIG. 5D, the spatial coins 518/524 are displayed at respective locations in the three-dimensional environments 550A/550B that are different from the locations to which the avatars 516/514 are moved in their respective three-dimensional environments. For example, in FIG. 5D, the spatial coin 534 remains displayed within the field of view of the first electronic device 101a (e.g., despite the avatar 514, which corresponds to the three-dimensional visual representation of the second user 504, being moved to within the ceiling in the side view 510), and the spatial coin 518 remains displayed within the field of view of the second electronic device 101b (e.g., despite the avatar 516, which corresponds to the three-dimensional visual representation of the first user 502, being moved to within the surface of the table 530 in the side view 512).

In FIG. 5D, the first electronic device 101a detects an input performed by the hand 503 of the first user 502 corresponding to a request to move the virtual object 507 in the three-dimensional environment 550A relative to the viewpoint of the first electronic device 101a. For example, as shown in FIG. 5D, the first electronic device 101a detects the hand 503 perform an air pinch and drag gesture performed by the hand 503, optionally while the gaze 526 of the first user 502 is directed to the grabber 511 in the three-dimensional environment 550A. In some examples, as indicated in FIG. 5D, the movement input provided by the hand 503 corresponds to a request to move the virtual object 507 vertically upward in the three-dimensional environment 550A relative to the viewpoint of the first electronic device 101a.

In some examples, as shown in FIG. 5E, in response to detecting the movement of the hand 503 of the first user 502, the first electronic device 101a moves the virtual object 507 vertically upward in the three-dimensional environment 550A relative to the viewpoint of the first electronic device 101a in accordance with the movement of the hand 503. Additionally, as previously discussed above, in some examples, because the movement input provided by the hand 503 is directed to a shared virtual object, the first electronic device 101a performs spatial refinement in accordance with the movement of the hand 503. For example, as shown in the side view 510 in FIG. 5E, the first electronic device 101a (e.g., concurrently) moves the avatars 514/519 and the virtual object 507 vertically upward in the three-dimensional environment 550A in accordance with the upward movement of the hand 503 (e.g., in accordance with a magnitude of the movement of the hand 503). Additionally, in some examples, as shown in side view 512 in FIG. 5E, to maintain spatial truth within the spatial group of the first user 502, the second user 504, and the third user, the second electronic device 101b (e.g., and the third electronic device) moves the avatar 516 corresponding to the first user 502 (e.g., vertically downward) in the three-dimensional environment 550B based on the movement input detected at the first electronic device 101a (e.g., without moving the avatar 519 and the virtual object 507 in the three-dimensional environment 550B), as similarly discussed above.

As shown in FIG. 5E, in some examples, the vertical movement of the virtual object 507, the avatar 514, and the avatar 519 in the three-dimensional environment 550A corresponds to movement of the avatar 514 further upward in the three-dimensional environment 550A and into the upper boundary of the three-dimensional environment 550A (e.g., defined by the ceiling), as illustrated in the side view 510. Additionally, in the example of FIG. 5E, the vertical movement of the virtual object 507, the avatar 514, and the avatar 519 corresponds to movement of the avatar 519 corresponding to the third user into the upper boundary of the three-dimensional environment 550A, as illustrated in the side view 510. Accordingly, as similarly discussed above, the first electronic device 101a replaces display of the avatar 519 in the three-dimensional environment 550A with spatial coin 536, which corresponds to a two-dimensional visual representation of the third user. In some examples, the spatial coin 536 has one or more characteristics of the spatial coins 518/534 discussed above.

In some examples, in accordance with a determination that a respective three-dimensional visual representation of a respective user is redisplayed as a two-dimensional visual representation (e.g., a spatial coin) as a result of the three-dimensional visual representation at least partially intersecting with a boundary of the three-dimensional environment in which the three-dimensional visual representation is displayed, a respective electronic device updates display of all three-dimensional visual representations of users of the electronic devices to be two-dimensional visual representations in the three-dimensional environment (e.g., irrespective of which three-dimensional visual representations are actually intersecting with a boundary of a respective three-dimensional environment). For example, in FIG. 5E, as illustrated in the side view 512, the avatar 519 has not been moved into a boundary of the three-dimensional environment 550B at the second electronic device 101b (e.g., in response to the user input detected at the first electronic device 101a or the second electronic device 101b). However, as shown in FIG. 5E, because at least one of the avatars representing a user of an electronic device in the multi-user communication has been moved into a boundary of the three-dimensional environment at the electronic device, the second electronic device 101b replaces display of the avatar 519 corresponding to the third user with the spatial coin 536 discussed previously above. For example, at the second electronic device 101b, the avatar 516 corresponding to the first user 502 has been moved into the boundary of the three-dimensional environment 550B defined by the surface of the table 530, as illustrated in the side view 512 in FIG. 5E, which causes the second electronic device 101b to replace display of both of the avatars 516/519 with their respective spatial coins 518/536. In this way, consistency of display of the visual representations is maintained across the electronic devices in the multi-user communication session as it pertains to whether users of the electronic devices are being represented spatially (e.g., via a three-dimensional visual representation) of non-spatially (e.g., via a two-dimensional visual representation) in the three-dimensional environment, which helps improve overall user experience in the multi-user communication session by synchronizing the particular display of the visual representations and interactions therebetween.

FIGS. 5F-5G illustrate alternative examples of facilitating vertical movement of a shared virtual object, which triggers spatial refinement of the shared virtual objects in the multi-user communication session. For example, in FIG. 5F, while the first user 502, the second user 504, and the third user (e.g., not shown) are in the multi-user communication session via their respective electronic devices, the first electronic device 101a and the second electronic device 101b are displaying the virtual object 507, which corresponds to a shared object in the multi-user communication session, as similarly discussed above. Additionally, in some examples, as shown in FIG. 5F, the first electronic device 101a is displaying the spatial coin 534 corresponding to the second user 504 and the spatial coin 536 corresponding to the third user in the three-dimensional environment 550A. In some examples, as shown in FIG. 5F, the second electronic device 101b is displaying the avatar 516 corresponding to the first user 502 and the avatar 519 corresponding to the third user in the three-dimensional environment 550B.

In some examples, a display state of the visual representations of the users in the multi-user communication session need not be maintained (e.g., synchronized) across all the electronic devices associated with the users in the multi-user communication session. Particularly, in some examples, as shown in FIG. 5F, the first electronic device 101a is displaying the visual representations of the second user 504 and the third user as non-spatial two-dimensional representations (e.g., the spatial coins 534/536) in the three-dimensional environment 550A, while the second electronic device 101b is displaying the visual representations of the first user 502 and the third user as spatial three-dimensional representations (e.g., the avatars 516/519) in the three-dimensional environment 550B. In some examples, the asynchronous display states of the visual representations of the users in the multi-user communication session is specific to the locations of the visual representations relative to one or more boundaries of the three-dimensional environments of the users in the multi-user communication session. For example, as shown in the side view 510 in FIG. 5F, the visual representations of the second user 504 and the third user are positioned at least partially outside of and/or beyond a boundary of the three-dimensional environment 550A (e.g., such as into a ceiling of the physical environment and/or outside of vertical threshold distance 547 (e.g., a threshold elevation and/or height) relative to a head of the first user 502, such as more than 0.25, 0.5, 0.75, 1, 1.5, 2, or 3 meters above the head of the first user 502), which causes the first electronic device 101a to display the visual representations as the spatial coins 534/536 in the three-dimensional environment 550A. On the other hand, as illustrated in the side view 512 in FIG. 5F, the visual representations of the first user 502 and the third user are positioned within the boundaries of the three-dimensional environment 550B (e.g., such as above the floor or ground of the physical environment that is visible in the three-dimensional environment 550B), which enables the second electronic device 101b to display the visual representations as the avatars 516/519 in the three-dimensional environment 550B.

In some examples, though the display of the visual representations of the users in the multi-user communication session is not limited and/or constrained by one or more boundaries of a respective user's three-dimensional environment, the display of the content being shared within the multi-user communication session is limited and/or constrained by the one or more boundaries of the respective user's three-dimensional environment. In FIG. 5F, the first electronic device 101a detects an input provided by the hand 503 of the first user 502 corresponding to a request to move the virtual object 507 in the three-dimensional environment 550A relative to the viewpoint of the first electronic device 101a. For example, as shown in FIG. 5F, the first electronic device 101a detects the hand 503 perform and air pinch and drag gesture, optionally while the gaze 526 of the first user 502 is directed to the grabber 511 associated with the virtual object 507 in the three-dimensional environment 550A. In some examples, as indicated in FIG. 5F, the movement of the hand 503 corresponds to a request to move the virtual object 507 vertically upward in the three-dimensional environment 550A relative to the viewpoint of the first electronic device 101a. In some examples, the input provided by the hand 503 is detected by the first electronic device 101a while the virtual object 507 is located at a location in the three-dimensional environment 550A that is within one or more boundaries of the three-dimensional environment 550A. For example, as illustrated in the side view 510 in FIG. 5F, the first electronic device 101a detects the input discussed above while the virtual object 507 is displayed at a location having an elevation (e.g., a height) that is above the floor or ground of the physical environment in which the first user 502 is located (e.g., corresponding to a minimum boundary) and below a maximum boundary defined by the threshold distance 547. In some examples, the threshold distance 547 is measured relative to the position of the first electronic device 101a on the head of the first user 502. In some examples, the threshold distance 547 is measured relative to the head of the first user 502 irrespective of a body pose of the first user 502 in the physical environment of the first user 502 (e.g., irrespective of whether the first user 502 is sitting (e.g., as illustrated in the side view 510 in FIG. 5F) or standing (e.g., as similarly illustrated by the second user 504 in the side view 512 in FIG. 5F)). In some examples, the maximum boundary corresponds to the ceiling or other physical object or limitation of the physical environment in which the first user 502 is located.

In some examples, as illustrated in FIG. 5G, the input directed to the virtual object 507 corresponds to a request to move the virtual object 507 vertically beyond the maximum or upper boundary of the three-dimensional environment 550A. For example, as illustrated in the side view 510 in FIG. 5G, the first electronic device 101a moves the virtual object 507 up and outside of the threshold distance 547 relative to the head of the first user 502 in the three-dimensional environment 550A in accordance with the movement of the hand 503. Additionally, in some examples, as previously described herein, the vertical movement of the virtual object 507 in the three-dimensional environment 550A in response to the input provided by the hand 503 triggers spatial refinement in the multi-user communication session (e.g., because the virtual object 507 is shared within the multi-user communication session). Accordingly, in some examples, as shown in FIG. 5G, when the virtual object 507 is moved upward in the three-dimensional environment 550A relative to the viewpoint of the first electronic device 101a, the spatial coins 534/536 are moved further vertically upward in the three-dimensional environment 550A with the virtual object 507, such that the spatial coins 534/536 are no longer (e.g., are not currently) visible in the three-dimensional environment 550A from the viewpoint of the first electronic device 101a. In some examples, in response to detecting input that causes a shared virtual object to be moved vertically outside of and/or beyond a boundary of a three-dimensional environment within a multi-user communication session, a “rubberbanding” effect is applied to the movement of the shared virtual object in the three-dimensional environment. Particularly, in the example of FIG. 5G, a physics-based model of movement (e.g., a set of simulated laws of physics, such as a spring-based model (e.g., Hooke's law)) is applied to the vertical movement of the virtual object 507 beyond the upper boundary in the three-dimensional environment 550A, as discussed in more detail below. In FIG. 5G, the first electronic device 101a detects that the hand 503 of the first user 502 continues to maintain the air pinch gesture, but optionally ceases detection of the movement of the hand 503.

In some examples, while the physics-based model of movement is applied to the vertical movement of the virtual object 507 beyond the upper boundary in the three-dimensional environment 550A, further and/or additional movement of the virtual object 507 that causes the virtual object 507 to be moved further beyond the upper boundary in the three-dimensional environment 550A is met with greater magnitudes of simulated resistance. For example, in FIG. 5G, if the first electronic device 101a detects further movement of the hand 503 while maintaining the air pinch gesture, a distance that the virtual object 507 is moved vertically beyond the upper boundary (e.g., beyond the threshold distance 547) is proportional to the magnitude (e.g., of distance) of the movement of the hand 503, but is moved a progressively lesser distance in response to detecting continued movement of the hand 503, due to the simulated resistance. In some examples, the simulated resistance increases proportionally, exponentially, and/or some other combination based on a distance the virtual object 507 is moved beyond the boundary in the three-dimensional environment 550A.

In some examples, as shown in FIG. 5H, in response to detecting termination (e.g., an end) of the air pinch gesture provided by the hand 503, the first electronic device 101a “rubberbands” the virtual object 507, such that the virtual object 507 is no longer displayed at a location that is beyond the upper boundary (e.g., outside of the threshold distance 547) and is moved to a location that is within the one or more boundaries (e.g., within the threshold distance 547 relative to the head of the first user 502) in the three-dimensional environment 550A from the viewpoint of the first electronic device 101a. For example, despite the movement of the virtual object 507 in accordance with the movement of the hand 503 causing the virtual object 507 to be moved beyond and (e.g., temporarily) displayed at a location outside of the maximum boundary in the three-dimensional environment 550A, in response to detecting the end of the input provided by the hand 503, the first electronic device 101a applies the rubberbanding effect to the virtual object 507 to maintain display of the virtual object 507 at a location that is below the maximum boundary in the three-dimensional environment 550A from the viewpoint of the first electronic device 101a. In some examples, detecting the termination of the input provided by the hand 503 of the first user 502 includes detecting a release of the air pinch gesture, such as the index finger and thumb of the hand 503 are no longer in contact. In some examples, detecting the termination of the input provided by the hand 503 of the first user 502 includes detecting an updated posture of the hand 503 and/or arm of the first user 502, such as movement of the hand 503 to a resting posture or state (e.g., at a side of the first user 502). In some examples, the first electronic device 101a animates the movement of the virtual object 507 from the location that is outside and/or beyond the upper boundary (e.g., in FIG. 5G) to the location that is below and/or within the upper boundary (e.g., in FIG. 5H) according to the set of simulated laws of physics discussed above. For example, in response to detecting the termination of the input provided by the hand 503 from FIG. 5G to FIG. 5H, the first electronic device 101a determines an amount of displacement (e.g., a distance) between the location of the virtual object 507 in FIG. 5G and the location of the virtual object 507 in FIG. 5H, and animates a translation of the virtual object 507 with a magnitude (e.g., of acceleration) that is based on the displacement. In some examples, the relationship between the displacement and the simulated acceleration of the virtual object 507 moving back to the location that is within the one or more boundaries in the three-dimensional environment 550A is linear, exponential, logarithmic, and/or some other non-linear relationship.

In some examples, the above rubberbanding effect that is applied to the movement of the virtual object 507 is similarly applied to the visual representations (e.g., the spatial coins 534/536) of the second user 504 and the third user in the three-dimensional environment 550A when moving the visual representations relative to the viewpoint of the first electronic device 101a. For example, in FIG. 5H, when the termination of the input provided by the hand 503 is detected, the first electronic device 101a moves the spatial coins 534/536 in the three-dimensional environment 550A (e.g., downward in height/elevation toward the upper boundary of the three-dimensional environment 550A) with the downward movement of the virtual object 507 relative to the viewpoint of the first electronic device 101a (e.g., according to the set of simulated laws of physics discussed above). However, in the example of FIG. 5H, because visual representations of users in the multi-user communication session are able to be displayed and/or positioned beyond the one or more boundaries of the three-dimensional environment 550A, the application of the rubberbanding effect does not require the spatial coins 534/536 to also be moved to within the upper boundary in the three-dimensional environment 550A like the virtual object 507, thus causing the spatial coins 534/536 remain outside of the current field of view of the first electronic device 101a in the three-dimensional environment 550A relative to the viewpoint of the first electronic device 101a.

In some examples, as previously described herein, the above movement of the virtual object 507 in the three-dimensional environment 550A by the first electronic device 101a triggers spatial refinement in the multi-user communication session (e.g., because the virtual object 507 is shared within the multi-user communication session). Accordingly, though not illustrated in FIG. 5H, when the input proved by the hand 503 of the first user 502 is terminated, the second electronic device 101b moves the visual representation of the first user 502 (e.g., the avatar 516) in the three-dimensional environment 550B by a corresponding magnitude and/or direction. For example, as similarly discussed herein, because the first electronic device 101a has moved the virtual object 507 vertically upward in the three-dimensional environment 550A from FIG. 5F to FIG. 5H, the second electronic device 101b moves the avatar 516 vertically downward in the three-dimensional environment 550B relative to the viewpoint of the second electronic device 101b, and optionally by a corresponding amount of displacement (e.g., a corresponding vertical distance).

In some examples, enabling the virtual object 507 to (e.g., momentarily) be moved beyond a boundary of the three-dimensional environment 550A provides the first user 502 with visual feedback regarding the response to the input for moving the virtual object 507 in the three-dimensional environment 550A. Additionally, animating the movement of the virtual object 507 from the location that is beyond the boundary to the location that is within the boundary in the three-dimensional environment 550A according to the simulated laws of physics as outlined above helps prevent eye strain and general user discomfort associated with relocating the virtual object 507 to be within the boundary in the three-dimensional environment 550A and maintains visibility of the content of the virtual object 507 from the viewpoint of the user, as an advantage. It is understood that the above rubberbanding effect is similarly applied to movement of shared virtual object beyond additional or alternative boundaries in the three-dimensional environment, such as the minimum boundary discussed above corresponding to the floor or ground of the physical environment in which a particular user is located.

FIGS. 5I-5K illustrate alternative examples of facilitating vertical movement of a shared virtual object, which triggers spatial refinement of the shared virtual objects in the multi-user communication session. For example, in FIG. 5I, while the first user 502, the second user 504, and the third user (e.g., not shown) are in the multi-user communication session via their respective electronic devices, the first electronic device 101a and the second electronic device 101b are displaying virtual object 540, which corresponds to a shared object in the multi-user communication session. In some examples, as shown in FIG. 5I, the virtual object 540 is displayed with grabber or handlebar 541 (e.g., having one or more characteristics of the grabber 511 described above) and pill 542 indicating that the virtual object 540 is shared in the multi-user communication session, as similarly discussed above. Additionally, in some examples, the virtual object 540 is associated with a respective application running on the electronic device 101a/101b, such as a text editing application. In some examples, as previously discussed above, the three-dimensional environment 550A presented at the first electronic device 101a includes the avatar 514 corresponding to the second user 504 and the avatar 519 corresponding to the third user. Similarly, in some examples, the three-dimensional environment 550B presented at the second electronic device 101b includes the avatar 516 corresponding to the first user 502 and the avatar 519.

In FIG. 5I, the first electronic device 101a detects an input provided by the hand 503 of the first user 502 corresponding to a request to move the virtual object 540 in the three-dimensional environment 550A relative to the viewpoint of the first electronic device 101a. For example, as shown in FIG. 5I, the first electronic device 101a detects the hand 503 perform and air pinch and drag gesture, optionally while the gaze 526 of the first user 502 is directed to the grabber 541 associated with the virtual object 540 in the three-dimensional environment 550A. In some examples, as indicated in FIG. 5I, the movement of the hand 503 corresponds to a request to move the virtual object 540 vertically downward in the three-dimensional environment 550A relative to the viewpoint of the first electronic device 101a.

In some examples, as shown in FIG. 5J, in response to detecting the input provided by the hand 503 of the first user 502, the first electronic device 101a moves the virtual object 540 vertically downward in the three-dimensional environment 550A relative to the viewpoint of the first electronic device 101a in accordance with the movement of the hand 503. Additionally, as previously discussed above, in some examples, because the movement input provided by the hand 503 is directed to a shared virtual object, the first electronic device 101a performs spatial refinement in accordance with the movement of the hand 503. For example, as shown in the side view 510 in FIG. 5J, the first electronic device 101a (e.g., concurrently) moves the avatars 514/519 and the virtual object 540 vertically downward in the three-dimensional environment 550A in accordance with the downward movement of the hand 503 (e.g., in accordance with a magnitude of the movement of the hand 503). Additionally, in some examples, as shown in side view 512 in FIG. 5J, to maintain spatial truth within the spatial group of the first user 502, the second user 504, and the third user, the second electronic device 101b (e.g., and the third electronic device) moves the avatar 516 corresponding to the first user 502 (e.g., vertically upward) in the three-dimensional environment 550B based on the movement input detected at the first electronic device 101a (e.g., without moving the avatar 519 and the virtual object 540 in the three-dimensional environment 550B), as similarly discussed above.

In some examples, the first electronic device 101a spatially refines the avatars 514/519 and the virtual object 540 in the three-dimensional environment 550A in accordance with the movement of the hand 503 by moving the avatars 514/519 and the virtual object 507 relative to a respective surface in the three-dimensional environment 550A. For example, in FIG. 5C, the first electronic device 101a decreases a height of each of the avatars 514/519 and the virtual object 540 in the three-dimensional environment 550A, which is based on the movement of the hand 503, relative to a floor or ground of the physical environment in which the first electronic device 101a is located that is visible in the three-dimensional environment 550A. Particularly, in some examples, the first electronic device 101a correlates a magnitude (e.g., of distance) of the movement of the hand 503 in space relative to the viewpoint of the first electronic device 101a with a magnitude (e.g., of distance) of vertical movement of the avatars 514/519 and the virtual object 540 relative to the floor or ground in the three-dimensional environment 550A. In some examples, the vertical movement of the avatars 514/519 and the virtual object 540 is selected to be relative to the floor or ground in the three-dimensional environment 550A because, when the input provided by the hand 503 above is detected by the first electronic device 101a, the virtual object 540 is not positioned on (e.g., displayed on and/or anchored to) a surface of a physical object in the three-dimensional environment 550A, such as the desk 506. Additionally or alternatively, in some examples, the vertical movement of the avatars 514/519 and the virtual object 540 is selected to be relative to the floor or ground in the three-dimensional environment 550A because, when the input provided by the hand 503 above is detected by the first electronic device 101a, the virtual object 540 is or corresponds to a vertically oriented virtual object (e.g., an object of the second type as described above).

Alternatively, in some examples, in response to detecting an input directed to a shared virtual object within the multi-user communication session that corresponds to vertical movement of the shared virtual object, spatial refinement of the virtual objects within the multi-user communication session is selectively triggered based on a type of the shared virtual object. In some examples, the type of the shared virtual object is based on an orientation and/or dimensionality (e.g., volume) of the shared virtual object. For example, in FIG. 5I, the virtual object 540 is a vertically oriented virtual object, as illustrated in the side views 510 and 512, such that the content of the virtual object 540 (e.g., the text-editing user interface illustrated in the virtual object 540) is displayed on and/or contained within a front-facing surface of the virtual object 540. As another example, the virtual object 540 is a two-dimensional virtual object (e.g., a two-dimensional virtual window, as similarly discussed above). On the other hand, referring back to FIG. 5A above, the virtual object 507 is a different type of shared virtual object in the multi-user communication session. For example, in FIG. 5A, the virtual object 507 is a horizontally oriented virtual object, as illustrated in the side views 510 and 512, such that the content of the virtual object 507 (e.g., the image of the airplane illustrated in the virtual object 507) is displayed on and/or contained within a top surface of the virtual object 507. As another example, the virtual object 540 is a three-dimensional virtual object (e.g., a volumetric virtual object).

In some examples, in response to detecting an input directed to a shared virtual object within the multi-user communication session that corresponds to vertical movement of the shared virtual object, in accordance with a determination that the shared virtual object is a first type of virtual object (e.g., a horizontally oriented and/or a volumetric virtual object, such as the virtual object 507 in FIG. 5A), spatial refinement is triggered in the multi-user communication session. In some examples, in accordance with a determination that the shared virtual object is a second type of virtual object (e.g., a vertically oriented and/or a two-dimensional virtual object, such as the virtual object 540 in FIG. 5I), spatial refinement is not triggered in the multi-user communication session. In some examples, the determination of the type of the shared virtual object is based on data provided by the application with which the shared virtual object is associated. For example, in FIG. 5I, the first electronic device 101a determines that the virtual object 540 is a vertically oriented and/or a two-dimensional virtual object based on data provided by the text editing application that is running on the first electronic device 101a and with which the virtual object 540 is associated (e.g., the data provided by the text editing application identifies the virtual object 540 as having a vertical orientation and/or as not being a volumetric virtual object).

As discussed above, in the example of FIG. 5I, in response to detecting the input provided by the hand 503 of the first user 502 corresponding to the request to move the virtual object 540 vertically in the three-dimensional environment 550A, the first electronic device 101a determines the type of the virtual object 540 and based on this determination, selectively triggers spatial refinement in the multi-user communication session. As mentioned above, in FIG. 5I, the virtual object 540 corresponds to a vertically oriented and/or a two-dimensional virtual object. Accordingly, in some examples, in response to detecting the input provided by the hand 503 of the first user corresponding to the request to move the virtual object 540 vertically in the three-dimensional environment 550A, the first electronic device 101a forgoes triggering spatial refinement in the multi-user communication session. Particularly, as shown from FIG. 5I to FIG. 5K, the first electronic device 101a forgoes moving the virtual object 540 vertically (e.g., downward) in the three-dimensional environment 550A relative to the viewpoint of the first electronic device 101a. Further, in some examples, as shown in FIG. 5K, the first electronic device 101a forgoes moving the avatars 514/519 in the three-dimensional environment 550A in accordance with the movement of the hand 503 illustrated in FIG. 5I. Accordingly, in some examples, as shown in FIG. 5K, because spatial refinement is not triggered in the multi-user communication session in response to detecting the input provided by the hand 503 of the first user 502, the second electronic device 101b forgoes updating display of the avatar 516 corresponding to the first user 502 in the three-dimensional environment 550B. For example, as shown in FIG. 5K, the second electronic device 101b forgoes moving the avatar 516 vertically (e.g., upward) in the three-dimensional environment 550B relative to the viewpoint of the second electronic device 101b. In the instance in which the vertical movement of a shared virtual object, and thus spatial refinement, within a multi-user communication session is based on the type of the shared virtual object, input directed to the shared virtual object for moving the shared virtual object vertically does cause the shared virtual object to be moved vertically, and therefore does trigger spatial refinement, if the shared virtual object is a horizontally oriented virtual object as discussed above. For example, in FIG. 5A, the first electronic device 101a initiates the vertical movement of the virtual object 507 in the three-dimensional environment 550A and triggers spatial refinement in the multi-user communication session in response to detecting the input provided by hand 503 of the first user 502 because the virtual object 507 is a horizontally oriented virtual object and/or is a volumetric (e.g., three-dimensional) virtual object, as mentioned above.

Accordingly, as outlined above, providing systems and methods for facilitating vertical movement of virtual content in a shared three-dimensional environment while in a multi-user communication session advantageously enables users to participate in the multi-user communication session and experience synchronized movement of and interaction with the virtual content, thereby improving user-device interaction. Additionally, vertically moving virtual content in the shared three-dimensional environment relative to a particular surface that is selected based on an orientation associated with the virtual content helps improve accuracy of the movement of the virtual content based on the movement input directed to the virtual content, which helps reduce user input that would be needed for correcting for inconsistencies of the movement in the shared three-dimensional environment, thereby helping conserve computing resources that would otherwise be consumed to respond to such user input, as another benefit.

It is understood that the examples shown and described herein are merely exemplary and that additional and/or alternative elements may be provided within the three-dimensional environment for interacting with the illustrative content. It should be understood that the appearance, shape, form and size of each of the various user interface elements and objects shown and described herein are exemplary and that alternative appearances, shapes, forms and/or sizes may be provided. For example, the virtual objects representative of application windows (e.g., virtual objects 407, 432, 507 and 540) may be provided in an alternative shape than a rectangular shape, such as a circular shape, triangular shape, etc. In some examples, the various selectable options (e.g., option 423 and/or pills 417, 431, 517, and/or 542), user interface elements (e.g., menu element 424), etc. described herein may be selected verbally via user verbal commands (e.g., “select option” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

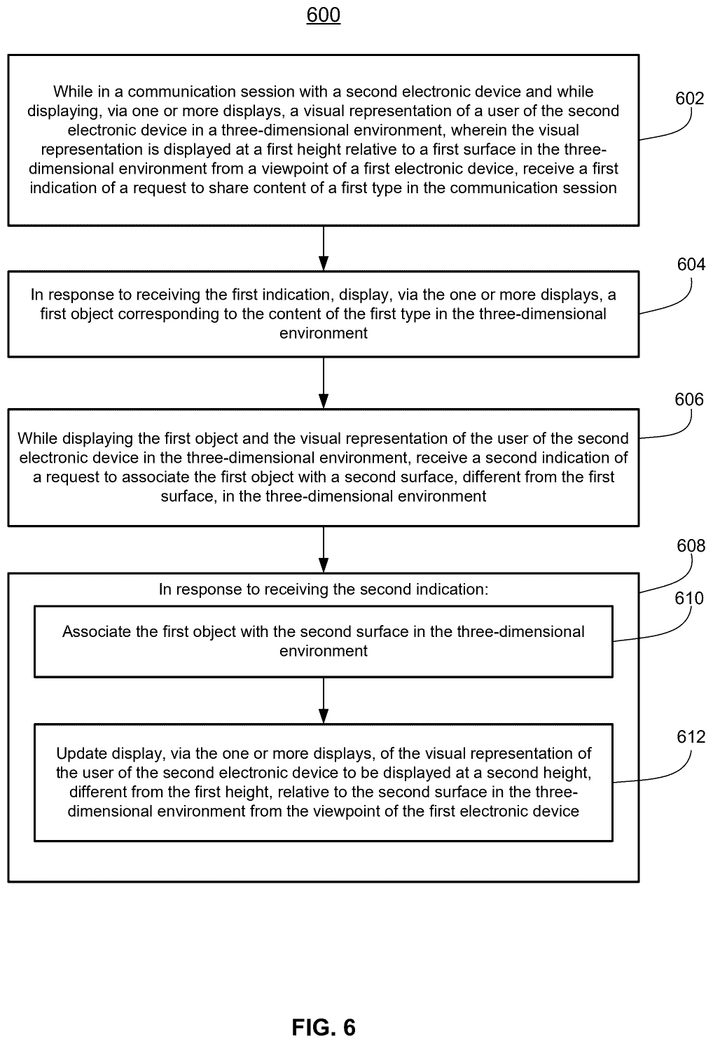

FIG. 6 illustrates a flow diagram illustrating an example process for presenting content in a three-dimensional environment relative to surfaces in the three-dimensional environment within a multi-user communication session according to some examples of the disclosure. In some examples, process 600 begins at a first electronic device in communication with one or more displays and one or more input devices. In some examples, the first electronic device is optionally a head-mounted display similar or corresponding to electronic device 260 of FIG. 2. As shown in FIG. 6, in some examples, at 602, while in a communication session with a second electronic device and while displaying, via the one or more displays, a visual representation of a user of the second electronic device in a three-dimensional environment, wherein the visual representation is displayed at a first height relative to a first surface in the three-dimensional environment from a viewpoint of the first electronic device, the first electronic device receives a first indication of a request to share content of a first type in the communication session. For example, as shown in FIG. 4A, first electronic device 101a detects a selection of pill 417 associated with virtual object 407 in three-dimensional environment 450A corresponding to a request to initiate sharing of the content of the virtual object 407 with second electronic device 101b. Additionally, in FIG. 4A, when the selection of the pill 417 is detected, the first electronic device 101a is displaying avatar 414 corresponding to second user 404 at a respective height relative to a floor or ground of the three-dimensional environment 450A.

In some examples, at 604, in response to receiving the first indication, the first electronic device displays, via the one or more displays, a first object corresponding to the content of the first type in the three-dimensional environment. For example, as shown in FIG. 4C, the first electronic device 101a updates display of the pill 417 of the virtual object 407 to indicate that the virtual object 407 has been shared in the multi-user communication session. In some examples, at 606, while displaying the first object and the visual representation of the user of the second electronic device in the three-dimensional environment, the first electronic device receives a second indication of a request to associate the first object with a second surface, different from the first surface, in the three-dimensional environment. For example, as shown in FIG. 4C, the first electronic device 101a detects a movement input provided by hand 403 of the first user 402 corresponding to a request to move the virtual object 407 to the surface of the desk 406 in the three-dimensional environment 450A.

In some examples, at 608, in response to receiving the second indication, at 610, the first electronic device associates the first object with the second surface in the three-dimensional environment. For example, as shown in FIG. 4E, the first electronic device 101a displays the virtual object 407 on the surface of the desk 406 and with a horizontal orientation in the three-dimensional environment 450A. In some examples, at 612, the first electronic device updates display, via the one or more displays, of the visual representation of the user of the second electronic device to be displayed at a second height, different from the first height, relative to the second surface in the three-dimensional environment from the viewpoint of the first electronic device. For example, as shown in side view 410 in FIG. 4E, the first electronic device 101a updates display of the avatar 414 corresponding to the second user 404 to be displayed at height 427 that is relative to the surface of the desk 406 in the three-dimensional environment 450A.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

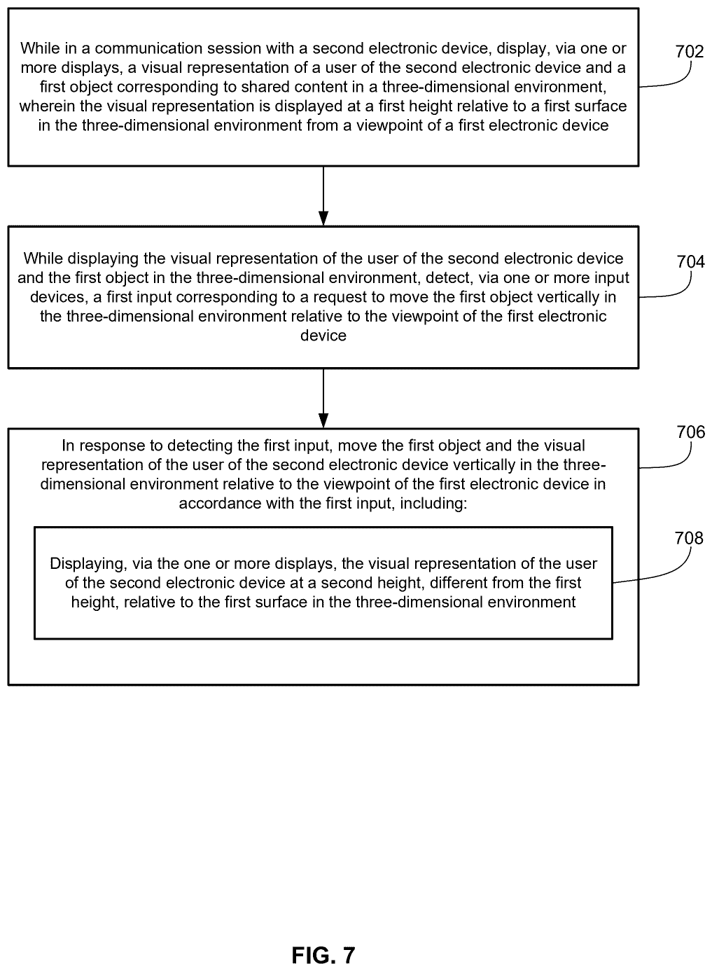

FIG. 7 illustrates a flow diagram illustrating an example process for moving shared content virtually in a three-dimensional environment relative to surfaces in the three-dimensional environment within a multi-user communication session according to some examples of the disclosure. In some examples, process 700 begins at a first electronic device in communication with one or more displays and one or more input devices. In some examples, the first electronic device is optionally a head-mounted display similar or corresponding to electronic device 260 of FIG. 2. As shown in FIG. 7, in some examples, at 702, while in a communication session with a second electronic device, the first electronic device displays, via the one or more displays, a visual representation of a user of the second electronic device and a first object corresponding to shared content in a three-dimensional environment, wherein the visual representation is displayed at a first height relative to a first surface in the three-dimensional environment from a viewpoint of the first electronic device. For example, as shown in FIG. 5A, while first electronic device 101a is in a multi-user communication session with second electronic device 101b, the first electronic device 101a is displaying virtual object 507 in three-dimensional environment 550A corresponding to a shared virtual object in the multi-user communication session. Additionally, in FIG. 5A, while the virtual object 507 is displayed in the three-dimensional environment 550A, the first electronic device 101a is displaying avatar 514 corresponding to second user 504 at a respective height relative to a surface of desk 506 in the three-dimensional environment 550A.

In some examples, at 704, while displaying the visual representation of the user of the second electronic device and the first object in the three-dimensional environment, the first electronic device detects, via the one or more input devices, a first input corresponding to a request to move the first object vertically in the three-dimensional environment relative to the viewpoint of the first electronic device. For example, as shown in FIG. 5A, the first electronic device 101a detects an input provided by hand 503 corresponding to a request to move the virtual object 507 vertically upward in the three-dimensional environment 550A relative to the viewpoint of the first electronic device 101a.

In some examples, at 706, in response to detecting the first input, the first electronic device moves the first object and the visual representation of the user of the second electronic device vertically in the three-dimensional environment relative to the viewpoint of the first electronic device in accordance with the first input. For example, as shown in FIG. 5C, the first electronic device 101a moves the virtual object 507 and the avatar 514 vertically upward in the three-dimensional environment 550A relative to the viewpoint of the first electronic device 101a in accordance with the movement of the hand 503. In some examples, at 708, the first electronic device displays, via the one or more displays, the visual representation of the user of the second electronic device at a second height, different from the first height, relative to the first surface in the three-dimensional environment. For example, in FIG. 5C, when the avatar 514 is moved vertically upward in the three-dimensional environment 550A, the avatar 514 is displayed with a height relative to the surface of the desk 506 in the three-dimensional environment 550A that is greater than the height of the avatar 514 relative to the surface of the desk 506 when the input provided by the hand 503 is detected in FIG. 5A.

It is understood that process 700 is an example and that more, fewer, or different operations can be performed in the same or in a different order. Additionally, the operations in process 700 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method comprising, at a first electronic device in communication with one or more displays and one or more input devices: while in a communication session with a second electronic device and while displaying, via the one or more displays, a visual representation of a user of the second electronic device in a three-dimensional environment, wherein the visual representation is displayed at a first height relative to a first surface in the three-dimensional environment from a viewpoint of the first electronic device, receiving a first indication of a request to share content of a first type in the communication session; in response to receiving the first indication, displaying, via the one or more displays, a first object corresponding to the content of the first type in the three-dimensional environment; while displaying the first object and the visual representation of the user of the second electronic device in the three-dimensional environment, receiving a second indication of a request to associate the first object with a second surface, different from the first surface, in the three-dimensional environment; and in response to receiving the second indication, associating the first object with the second surface in the three-dimensional environment, and updating display, via the one or more displays, of the visual representation of the user of the second electronic device to be displayed at a second height, different from the first height, relative to the second surface in the three-dimensional environment from the viewpoint of the first electronic device.

Additionally or alternatively, in some examples, the first surface in the three-dimensional environment corresponds to a physical floor or ground of a physical surface that is visible in the three-dimensional environment from the viewpoint of the first electronic device. Additionally or alternatively, in some examples, the second surface in the three-dimensional environment corresponds to a physical surface of a physical object that is visible in the three-dimensional environment from the viewpoint of the first electronic device. Additionally or alternatively, in some examples, the first surface in the three-dimensional environment corresponds to a physical floor or ground of a physical surface that is visible in the three-dimensional environment from the viewpoint of the first electronic device. Additionally or alternatively, in some examples, the method further comprises, while detecting the first input, displaying, via the one or more displays, a visual indication of a boundary associated with the movement of the first object in the three-dimensional environment, wherein the visual indication of the boundary is displayed on the first surface in the three-dimensional environment. Additionally or alternatively, in some examples, the second surface in the three-dimensional environment corresponds to a virtual surface of a virtual object displayed in the three-dimensional environment. Additionally or alternatively, in some examples, the virtual surface of the virtual object is positioned a respective height from the first surface in the three-dimensional environment relative to the viewpoint of the first electronic device, and the respective height is determined based on data provided by the second electronic device. Additionally or alternatively, in some examples, the virtual surface of the virtual object is positioned a respective height from the first surface in the three-dimensional environment relative to the viewpoint of the first electronic device, and the respective height is determined based on one or more physical characteristics of a physical environment of the first electronic device. Additionally or alternatively, in some examples, a height of the second surface in the three-dimensional environment is greater than a height of the first surface in the three-dimensional environment relative to the viewpoint of the first electronic device. Additionally or alternatively, in some examples, receiving the second indication of the request to associate the first object with the second surface in the three-dimensional environment includes detecting, via the one or more input devices, an input corresponding to a request to move the first object over the second surface in the three-dimensional environment. Additionally or alternatively, in some examples, associating the first object with the second surface in the three-dimensional environment includes anchoring the first object to the second surface in the three-dimensional environment.

Additionally or alternatively, in some examples, receiving the second indication of the request to associate the first object with the second surface in the three-dimensional environment includes visually identifying, via the one or more input devices, the second surface in the three-dimensional environment, without detecting input for associating the first object with the second surface in the three-dimensional environment. Additionally or alternatively, in some examples, the method further comprises: after receiving the second indication, receiving a third indication of a request to associate the first object with a third surface, different from the first surface and the second surface, in the three-dimensional environment; and in response to receiving the third indication, associating the first object with the third surface in the three-dimensional environment, and updating display, via the one or more displays, of the visual representation of the user of the second electronic device to be displayed at a third height, different from the first height and the second height, relative to the third surface in the three-dimensional environment from the viewpoint of the first electronic device. Additionally or alternatively, in some examples, the content of the first type corresponds to content that is associated with a horizontally-oriented virtual object. Additionally or alternatively, in some examples, the method further comprises: receiving a third indication of a request to share content of a second type, different from the first type, in the communication session; and in response to receiving the third indication, ceasing display of the first object in the three-dimensional environment, displaying, via the one or more displays, a second object corresponding to the content of the second type in the three-dimensional environment, and updating display, via the one or more displays, of the visual representation of the user of the second electronic device to be displayed at the first height relative to the first surface in the three-dimensional environment from the viewpoint of the first electronic device. Additionally or alternatively, in some examples, the content of the second type corresponds to content that is associated with a vertically-oriented virtual object.

Additionally or alternatively, in some examples, the method further comprises: prior to receiving the first indication of the request to share content of the first type in the communication session, receiving a third indication of a request to share content of a second type, different from the first type, in the communication session; and in response to receiving the third indication, displaying, via the one or more displays, a second object corresponding to the content of the second type in the three-dimensional environment; while displaying the second object and the visual representation of the user of the second electronic device in the three-dimensional environment, receiving a fourth indication of a request to associate the second object with the second surface in the three-dimensional environment; and in response to receiving the fourth indication, associating the second object with the second surface in the three-dimensional environment, and maintaining display, via the one or more displays, of the visual representation of the user of the second electronic device at the first height relative to the first surface in the three-dimensional environment from the viewpoint of the first electronic device. Additionally or alternatively, in some examples, the method further comprises: while the first object is associated with the second surface in the three-dimensional environment, receiving a third indication of a request to cease sharing of the content of the first type in the three-dimensional environment; and in response to receiving the third indication, ceasing display of the first object in the three-dimensional environment, and updating display, via the one or more displays, of the visual representation of the user of the second electronic device to be redisplayed at the first height relative to the first surface in the three-dimensional environment from the viewpoint of the first electronic device. Additionally or alternatively, in some examples, the first electronic device is further in the communication session with a third electronic device, the three-dimensional environment includes a second visual representation of a user of the third electronic device, and the second visual representation is displayed at a third height relative to the first surface in the three-dimensional environment from the viewpoint of the first electronic device. In some examples, the method further comprises, in response to receiving the second indication, updating display, via the one or more displays, of the second visual representation of the user of the third electronic device to be displayed at a fourth height, different from the third height, relative to the second surface in the three-dimensional environment from the viewpoint of the first electronic device. Additionally or alternatively, in some examples, the method further comprises, in response to receiving the second indication, displaying, via the one or more displays, a visual indication that indicates the display of the visual representation of the user of the second electronic device is being updated to be relative to the second surface in the three-dimensional environment.

Some examples of the disclosure are directed to a method comprising, at a first electronic device in communication with one or more displays and one or more input devices: while in a communication session with a second electronic device, displaying, via the one or more displays, a visual representation of a user of the second electronic device and a first object corresponding to shared content in a three-dimensional environment, wherein the visual representation is displayed at a first height relative to a first surface in the three-dimensional environment from a viewpoint of the first electronic device; while displaying the visual representation of the user of the second electronic device and the first object in the three-dimensional environment, detecting, via the one or more input devices, a first input corresponding to a request to move the first object vertically in the three-dimensional environment relative to the viewpoint of the first electronic device; and in response to detecting the first input, moving the first object and the visual representation of the user of the second electronic device vertically in the three-dimensional environment relative to the viewpoint of the first electronic device in accordance with the first input, including displaying, via the one or more displays, the visual representation of the user of the second electronic device at a second height, different from the first height, relative to the first surface in the three-dimensional environment.

Additionally or alternatively, in some examples, the first object corresponds to a vertically-oriented virtual object. Additionally or alternatively, in some examples, the first surface in the three-dimensional environment corresponds to a physical floor or ground of a physical surface that is visible in the three-dimensional environment from the viewpoint of the first electronic device. Additionally or alternatively, in some examples, the first object corresponds to a horizontally oriented virtual object. Additionally or alternatively, in some examples, the first surface in the three-dimensional environment corresponds to a physical surface of a physical object that is visible in the three-dimensional environment from the viewpoint of the first electronic device. Additionally or alternatively, in some examples, the visual representation of the user of the second electronic device corresponds to a three-dimensional avatar of the user of the second electronic device. Additionally or alternatively, in some examples, the method further comprises: while displaying the visual representation of the user of the second electronic device and the first object in the three-dimensional environment, receiving an indication of initiation of input detected by the second electronic device corresponding to a request to move the first object vertically in the three-dimensional environment; and while receiving the indication, updating display, via the one or more displays, of the visual representation of the user of the second electronic device to correspond to a two-dimensional representation in the three-dimensional environment. Additionally or alternatively, in some examples, the method further comprises: receiving an indication of completion of the input detected by the second electronic device corresponding to the request to move the first object vertically in the three-dimensional environment; and in response to receiving the indication, updating display, via the one or more displays, of the visual representation of the user of the second electronic device to correspond to the three-dimensional avatar of the user of the second electronic device, without moving the first object in the three-dimensional environment; wherein the visual representation of the user of the second electronic device is displayed at a third height, different from the first height and the second height, relative to the first surface in the three-dimensional environment. Additionally or alternatively, in some examples, the third height is based on a vertical distance of movement of the first object in a second three-dimensional environment presented at the second electronic device in accordance with the input detected by the second electronic device.

Additionally or alternatively, in some examples, in accordance with a determination that the movement of the first object vertically in the three-dimensional environment corresponds to movement away from the first surface in the three-dimensional environment, the second height is greater than the first height, and in accordance with a determination that the movement of the first object vertically in the three-dimensional environment corresponds to movement toward the first surface in the three-dimensional environment, the second height is less than the first height. Additionally or alternatively, in some examples, the first input includes an air gesture performed by a hand of a user of the first electronic device. Additionally or alternatively, in some examples, the method further comprises: while displaying the visual representation of the user of the second electronic device and the first object in the three-dimensional environment, detecting, via the one or more input devices, a second input corresponding to a request to move the first object vertically in the three-dimensional environment relative to the viewpoint of the first electronic device; and in response to detecting the second input, in accordance with a determination that the vertical movement of the first object in the three-dimensional environment corresponds to movement of the first object to a location in the three-dimensional environment beyond a boundary associated with the three-dimensional environment, moving the first object to a first location in the three-dimensional environment that is within the boundary relative to the viewpoint of the first electronic device, including updating display, via the one or more displays, of the visual representation of the user of the second electronic device to correspond to a two-dimensional representation in the three-dimensional environment.

Additionally or alternatively, in some examples, the boundary associated with the three-dimensional environment is defined as being a threshold distance from the first surface in the three-dimensional environment. Additionally or alternatively, in some examples, the boundary associated with the three-dimensional environment is defined as being a threshold distance from a head of a user of the first electronic device in the three-dimensional environment. Additionally or alternatively, in some examples, the method further comprises: while displaying the visual representation of the user of the second electronic device and the first object in the three-dimensional environment, detecting, via the one or more input devices, a second input corresponding to a request to move the first object vertically in the three-dimensional environment relative to the viewpoint of the first electronic device; and in response to detecting the second input, in accordance with a determination that the vertical movement of the first object in the three-dimensional environment corresponds to movement of the first object to a location in the three-dimensional environment beyond a boundary associated with the three-dimensional environment, moving the first object to a first location in the three-dimensional environment that is beyond the boundary relative to the viewpoint of the first electronic device in accordance with the second input; and after detecting termination of the second input, moving the first object to a second location, different from the first location, in the three-dimensional environment that is within the boundary relative to the viewpoint of the first electronic device. Additionally or alternatively, in some examples, the second input corresponds to a request to move the first object vertically in the three-dimensional environment by a first distance beyond the boundary, followed by a second distance beyond the boundary, and moving the first object to the first location in the three-dimensional environment in accordance with the second input includes: moving the first object by the first distance beyond the boundary in the three-dimensional environment relative to the viewpoint of the first electronic device; and after moving the first object by the first distance beyond the boundary, moving the first object by a third distance, less than the second distance, beyond the boundary in the three-dimensional environment relative to the viewpoint of the first electronic device.

Additionally or alternatively, in some examples, the method further comprises: while displaying the visual representation of the user of the second electronic device and the first object in the three-dimensional environment, receiving an indication of input detected by the second electronic device corresponding to a request to move the first object vertically in the three-dimensional environment; and in response to receiving the indication, moving the visual representation of the user of the second electronic device vertically in the three-dimensional environment relative to the viewpoint of the first electronic device. Additionally or alternatively, in some examples, the method further comprises, in response to receiving the indication, in accordance with a determination that the vertical movement of the visual representation of the second electronic device in the three-dimensional environment corresponds to movement of the first object to a location in the three-dimensional environment beyond a boundary associated with the three-dimensional environment, updating display, via the one or more displays, of the visual representation of the user of the second electronic device to correspond to a two-dimensional representation in the three-dimensional environment.

Some examples of the disclosure are directed to a first electronic device comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of a first electronic device, cause the first electronic device to perform any of the above methods.

Some examples of the disclosure are directed to a first electronic device, comprising one or more processors, memory, and means for performing any of the above methods.

Some examples of the disclosure are directed to an information processing apparatus for use in a first electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays and one or more input devices:
while in a communication session with a second electronic device and while displaying, via the one or more displays, a visual representation of a user of the second electronic device in a three-dimensional environment, wherein the visual representation is displayed at a first height relative to a first surface in the three-dimensional environment from a viewpoint of the first electronic device, receiving a first indication of a request to share content of a first type in the communication session;
in response to receiving the first indication, displaying, via the one or more displays, a first object corresponding to the content of the first type in the three-dimensional environment;
while displaying the first object and the visual representation of the user of the second electronic device in the three-dimensional environment, receiving a second indication of a request to associate the first object with a second surface, different from the first surface, in the three-dimensional environment; and
in response to receiving the second indication:
associating the first object with the second surface in the three-dimensional environment; and
updating display, via the one or more displays, of the visual representation of the user of the second electronic device to be displayed at a second height, different from the first height, relative to the second surface in the three-dimensional environment from the viewpoint of the first electronic device.

2. The method of claim 1, wherein the first surface in the three-dimensional environment corresponds to a physical floor or ground of a physical surface that is visible in the three-dimensional environment from the viewpoint of the first electronic device.

3. The method of claim 1, wherein the second surface in the three-dimensional environment corresponds to:
a physical surface of a physical object that is visible in the three-dimensional environment from the viewpoint of the first electronic device; or
a virtual surface of a virtual object displayed in the three-dimensional environment.

4. The method of claim 1, wherein a height of the second surface in the three-dimensional environment is greater than a height of the first surface in the three-dimensional environment relative to the viewpoint of the first electronic device.

5. The method of claim 1, wherein receiving the second indication of the request to associate the first object with the second surface in the three-dimensional environment includes detecting, via the one or more input devices, an input corresponding to a request to move the first object over the second surface in the three-dimensional environment.

6. The method of claim 1, wherein receiving the second indication of the request to associate the first object with the second surface in the three-dimensional environment includes visually identifying, via the one or more input devices, the second surface in the three-dimensional environment, without detecting input for associating the first object with the second surface in the three-dimensional environment.

7. The method of claim 1, further comprising:
receiving a third indication of a request to share content of a second type, different from the first type, in the communication session; and
in response to receiving the third indication:
ceasing display of the first object in the three-dimensional environment;
displaying, via the one or more displays, a second object corresponding to the content of the second type in the three-dimensional environment; and
updating display, via the one or more displays, of the visual representation of the user of the second electronic device to be displayed at the first height relative to the first surface in the three-dimensional environment from the viewpoint of the first electronic device.

8. The method of claim 1, further comprising:
while the first object is associated with the second surface in the three-dimensional environment, receiving a third indication of a request to cease sharing of the content of the first type in the three-dimensional environment; and
in response to receiving the third indication:
ceasing display of the first object in the three-dimensional environment; and
updating display, via the one or more displays, of the visual representation of the user of the second electronic device to be redisplayed at the first height relative to the first surface in the three-dimensional environment from the viewpoint of the first electronic device.

9. A first electronic device comprising:
one or more processors;
memory; and
one or more programs stored in the memory and configured to be executed by the one or more processors, the one or more programs including instructions for performing a method comprising:
while in a communication session with a second electronic device and while displaying, via one or more displays, a visual representation of a user of the second electronic device in a three-dimensional environment, wherein the visual representation is displayed at a first height relative to a first surface in the three-dimensional environment from a viewpoint of the first electronic device, receiving a first indication of a request to share content of a first type in the communication session;
in response to receiving the first indication, displaying, via the one or more displays, a first object corresponding to the content of the first type in the three-dimensional environment;
while displaying the first object and the visual representation of the user of the second electronic device in the three-dimensional environment, receiving a second indication of a request to associate the first object with a second surface, different from the first surface, in the three-dimensional environment; and
in response to receiving the second indication:
associating the first object with the second surface in the three-dimensional environment; and
updating display, via the one or more displays, of the visual representation of the user of the second electronic device to be displayed at a second height, different from the first height, relative to the second surface in the three-dimensional environment from the viewpoint of the first electronic device.

10. The first electronic device of claim 9, wherein the first surface in the three-dimensional environment corresponds to a physical floor or ground of a physical surface that is visible in the three-dimensional environment from the viewpoint of the first electronic device.

11. The first electronic device of claim 9, wherein the second surface in the three-dimensional environment corresponds to:
a physical surface of a physical object that is visible in the three-dimensional environment from the viewpoint of the first electronic device; or
a virtual surface of a virtual object displayed in the three-dimensional environment.

12. The first electronic device of claim 9, wherein a height of the second surface in the three-dimensional environment is greater than a height of the first surface in the three-dimensional environment relative to the viewpoint of the first electronic device.

13. The first electronic device of claim 9, wherein receiving the second indication of the request to associate the first object with the second surface in the three-dimensional environment includes detecting, via one or more input devices, an input corresponding to a request to move the first object over the second surface in the three-dimensional environment.

14. The first electronic device of claim 9, wherein receiving the second indication of the request to associate the first object with the second surface in the three-dimensional environment includes visually identifying, via one or more input devices, the second surface in the three-dimensional environment, without detecting input for associating the first object with the second surface in the three-dimensional environment.

15. The first electronic device of claim 9, wherein the method further comprises:
receiving a third indication of a request to share content of a second type, different from the first type, in the communication session; and
in response to receiving the third indication:
ceasing display of the first object in the three-dimensional environment;
displaying, via the one or more displays, a second object corresponding to the content of the second type in the three-dimensional environment; and
updating display, via the one or more displays, of the visual representation of the user of the second electronic device to be displayed at the first height relative to the first surface in the three-dimensional environment from the viewpoint of the first electronic device.

16. The first electronic device of claim 9, wherein the method further comprises:
while the first object is associated with the second surface in the three-dimensional environment, receiving a third indication of a request to cease sharing of the content of the first type in the three-dimensional environment; and
in response to receiving the third indication:
ceasing display of the first object in the three-dimensional environment; and
updating display, via the one or more displays, of the visual representation of the user of the second electronic device to be redisplayed at the first height relative to the first surface in the three-dimensional environment from the viewpoint of the first electronic device.

17. A non-transitory computer readable storage medium storing one or more programs, the one or more programs comprising instructions, which when executed by one or more processors of a first electronic device, cause the first electronic device to perform a method comprising:
while in a communication session with a second electronic device and while displaying, via one or more displays, a visual representation of a user of the second electronic device in a three-dimensional environment, wherein the visual representation is displayed at a first height relative to a first surface in the three-dimensional environment from a viewpoint of the first electronic device, receiving a first indication of a request to share content of a first type in the communication session;
in response to receiving the first indication, displaying, via the one or more displays, a first object corresponding to the content of the first type in the three-dimensional environment;
while displaying the first object and the visual representation of the user of the second electronic device in the three-dimensional environment, receiving a second indication of a request to associate the first object with a second surface, different from the first surface, in the three-dimensional environment; and
in response to receiving the second indication:
associating the first object with the second surface in the three-dimensional environment; and
updating display, via the one or more displays, of the visual representation of the user of the second electronic device to be displayed at a second height, different from the first height, relative to the second surface in the three-dimensional environment from the viewpoint of the first electronic device.

18. The non-transitory computer readable storage medium of claim 17, wherein the first surface in the three-dimensional environment corresponds to a physical floor or ground of a physical surface that is visible in the three-dimensional environment from the viewpoint of the first electronic device.

19. The non-transitory computer readable storage medium of claim 17, wherein the second surface in the three-dimensional environment corresponds to:
a physical surface of a physical object that is visible in the three-dimensional environment from the viewpoint of the first electronic device; or
a virtual surface of a virtual object displayed in the three-dimensional environment.

20. The non-transitory computer readable storage medium of claim 17, wherein a height of the second surface in the three-dimensional environment is greater than a height of the first surface in the three-dimensional environment relative to the viewpoint of the first electronic device.

21. The non-transitory computer readable storage medium of claim 17, wherein receiving the second indication of the request to associate the first object with the second surface in the three-dimensional environment includes detecting, via one or more input devices, an input corresponding to a request to move the first object over the second surface in the three-dimensional environment.

22. The non-transitory computer readable storage medium of claim 17, wherein receiving the second indication of the request to associate the first object with the second surface in the three-dimensional environment includes visually identifying, via one or more input devices, the second surface in the three-dimensional environment, without detecting input for associating the first object with the second surface in the three-dimensional environment.

23. The non-transitory computer readable storage medium of claim 17, further comprising:
receiving a third indication of a request to share content of a second type, different from the first type, in the communication session; and
in response to receiving the third indication:
ceasing display of the first object in the three-dimensional environment;
displaying, via the one or more displays, a second object corresponding to the content of the second type in the three-dimensional environment; and
updating display, via the one or more displays, of the visual representation of the user of the second electronic device to be displayed at the first height relative to the first surface in the three-dimensional environment from the viewpoint of the first electronic device.

24. The non-transitory computer readable storage medium of claim 17, further comprising:
while the first object is associated with the second surface in the three-dimensional environment, receiving a third indication of a request to cease sharing of the content of the first type in the three-dimensional environment; and
in response to receiving the third indication:
ceasing display of the first object in the three-dimensional environment; and
updating display, via the one or more displays, of the visual representation of the user of the second electronic device to be redisplayed at the first height relative to the first surface in the three-dimensional environment from the viewpoint of the first electronic device.
